(19) United States
(12) Patent Application Publication
(10) Pub. No.: US 2025/0168196 A1
(43) Pub. Date: May 22, 2025

(54) SYSTEM AND METHOD FOR DETECTING AND PREVENTING SOCIAL ENGINEERING ATTACKS AND ADVERTISEMENTS

(71) Applicants: Georgia Tech Research Corporation, Atlanta, GA (US); UNIVERSITY OF GEORGIA RESEARCH FOUNDATION, INC., Athens, GA (US)

(72) Inventors: Zheng Yang, Atlanta, GA (US); Wenke Lee, Atlanta, GA (US); Roberto Perdisci, Dacula, GA (US)

(21) Appl. No.: 18/951,037

(22) Filed: Nov. 18, 2024

Related U.S. Application Data
(60) Provisional application No. 63/600,280, filed on Nov. 17, 2023.

(51) Int. Cl. H04L 9/40

(52) U.S. Cl. CPC H04L 63/1441; H04L 63/1416

(57) ABSTRACT

An exemplary system and method are disclosed that can mitigate online social engineering attacks at scale using a real-time detection system configured to identify social engineering advertisements and to block users' navigation to potential social engineering websites. To detect SE-ads and block the subsequent events, the exemplary system and method can monitor a user's browsing session and evaluate each navigation to determine if it may be related to an SE-ad using trained AI features related to how the navigation was initiated and employing the features in a classification evaluation. Upon detection, the exemplary system and method can output a notification to warn the user.

### RELATED APPLICATION

This U.S. application claims priority to, and the benefit of, U.S. Provisional Patent Application No. 63/600,280, filed Nov. 17, 2023, entitled “REAL-TIME SCALE MITIGATION: DETECTING AND COUNTERING GENERIC WEB-BASED SOCIAL ENGINEERING ATTACKS THROUGH ONLINE SOCIAL ENGINEER AD DETECTION,” which is incorporated by reference herein in its entirety.

### STATEMENT REGARDING FEDERALLY SPONSORED RESEARCH OR DEVELOPMENT

This invention was made with government support under CNS-2126641, awarded by the National Science Foundation, and N00014-17-1-2179, N00014-17-1-2895, N00014-15-1-2162, N00014-18-1-2662 awarded by the Office of Naval Research. The government has certain rights in the invention.

### BACKGROUND

Social Engineering (SE) has become a sophisticated and common attack method. Recent surveys report that 84% of hackers leverage Web-based Social Engineering Attacks (WSEAs) in the cyber kill chain with a high success rate. Moreover, 64% of companies have experienced web-based attacks, and 62% have seen phishing and WSEAs. Attackers also target regular Internet users. The Federal Trade Commission received 2.8 million fraud reports in 2021 in the United States, which led to a $5.8 billion financial loss. The top 3 fraud categories—impostor scams, online shopping scams, and reward and prize scams—are commonly seen on the Internet. These scams account for $2.3 billion of losses, almost doubling from 2020.

The current state-of-the-art advertisement blockers (i.e., ad-blockers) cannot mitigate SE attacks the users encounter as the SE attacks are diverse and configured to evade the detection and blocking operations of the current state-of-the-art ad-blockers.

There would be, therefore, a benefit to improving the advertisement detection and blocking system.

### SUMMARY

An exemplary system and method are disclosed that can mitigate generic online social engineering attacks at scale using a real-time detection system configured to identify social engineering advertisements (SE-ads) and to block users' navigation to potential social engineering websites (SE-websites). To detect SE-ads and block the subsequent events, the exemplary system and method can monitor a user's browsing session via instrumented hooks embedded in the browser and evaluate each navigation to determine if it may be related to an SE-ad using trained artificial intelligence (AI) features related to how the navigation was initiated and employing the features in a classification evaluation. Upon detection, the exemplary system and method can output a notification (e.g., interstitial page, warning message) to warn the user.

The exemplary system and method take advantage of two intuitions: (1) SE-ads use tricks (e.g., click-jacking and social engineering) to lure users into interacting with strategically placed document object model (DOM) elements and triggering unwanted browser navigation; and (2) SE-ads often redirect the user to malicious websites that host social engineering attacks (e.g., tech support scams, malicious downloads, etc.).

The exemplary system and method beneficially place the detection in the choke point (low-tier ad networks) where online social engineering attacks are distributed at scale rather than detecting, via conventional operation, specific online social engineering attacks such as scamming, untrusted software downloading, spamming, etc. The exemplary system and method can thus effectively block potential navigation to social engineering websites regardless of the type of attack.

In a study, the exemplary system and method are implemented in Chromium via an extension that extends the Chrome DevTools Protocol framework with a Social-engineering agent. The study evaluated having a user visit a website to which the agent then collects JavaScript actions (e.g., event listener registrations, DOM modifications) and sends them to a background daemon. The background daemon built an in-memory graph representation of the web page and its activities. While constructing the graph, the system extracted property features, action features, and consequence features from the graph.

In an aspect, a system is disclosed comprising a processor; and a memory having instruction stored thereon, wherein execution of the instructions causes the processor to execute a user interface module, a browser engine, a rendering engine, a networking module, a JavaScript engine, and a data storage module for a web browser; in response to initiating a browsing session for a new website by a user, receive a set of property values, a set of action values, and a set of consequence values associated with the browsing session for the new website from instrumented hooks embedded in the browser engine, the rendering engine, the networking module, the JavaScript engine, and the data storage module; determine, via a trained AI model, a score for the browsing session being associated with a website having a malicious component; and output the score, wherein the score is employed to prevent the user from selecting an actionable component in a rendered website.

In some embodiments, execution of the instructions further causes the processor to output a notification indicating presence of an actionable component for a rendered website.

In some embodiments, the set of property values is associated with a compilation and execution of a script of the rendered website and includes at least one of an execution context of a running script as a top frame or a subframe, an execution context of the running script having a same origin frame or cross-origin frame, a type of script as an inline script in HTML, a type of script as a remote script file, a type of script as a dynamically generated script, an owner of the script being served by a first-party server, an owner of the script being served by a third-party server, a requestor being an HTML parser, and a requestor being from another script that is not an HTML parser.

In some embodiments, the set of action values is associated with an observed behavior exhibited by a script of the rendered website and includes at least one of a register event listener action having an event type associated with a keyboard, mouse, and/or hover, a register event listener action having an event target as a type of DOM element, an add timer callback action as a setTimeout, an add timer callback action as a setInterval, an add timer callback action as an interval, an insert DOM node action using an <a > inserted node type, an insert DOM node action using a <script> inserted node, an insert DOM node action using a <div> inserted node, a modify DOM node attribute, a modify DOM node attribute action using a “style” attribute, a modify DOM node attribute, a modify DOM node attribute action using a “href” attribute, a modify DOM node attribute, a modify DOM node attribute action using a “src” attribute, an open-new-window action using an URL for a new window, a render-window using a tab window from an open-new-window action, a render-window using a full window from an open-new-window action, an initiate navigation action with a URL of a navigation target, an initiate navigation action from a top frame, an initiate navigation action with a URL from an iframe, an initiate navigation action within a same-origin, an initiate navigation action by a client code, an initiate navigation action by the browser by user action, a send network request action via a URL of the request, a send network action via a script, a send network action via an image, a send network action via a document, and a send network action via a JavaScript object notation (Json).

In some embodiments, the set of consequence values is associated with an observed behavior of the browser after navigation from the rendered website and includes at least one of a number of redirected hops until landing at a destination page, a number of unique domains of the redirected hops, a redirect type being code-driven, and a redirect type being response-header-driven.

In some embodiments, the trained AI model was trained using a set of features populated using a web crawler, wherein the web crawler was configured to simulate user interactions with the respective website to trigger one or more JavaScript events.

In some embodiments, the trained AI model was trained using a set of features populated using a web crawler, wherein the web crawler was configured to create an in-memory graph where, after visiting each respective website, the graph is dumped into a disk and features are extracted based on a causality relationship of nodes for each website.

In some embodiments, the initiating the browsing session includes parsing, via an HTML parser, an HTML document to start rendering a page, wherein the parsing, constructing an in-memory graph, and updating the in-memory graph when a respective instrumented hook embedded in the browser engine is triggered.

In some embodiments, the initiating the browsing session includes concluding a feature vector before the browser commits to a new landing page to infer whether the navigation is related to a social engineering attack.

In another aspect, a method is disclosed comprising executing a user interface module, a browser engine, a rendering engine, a networking module, a JavaScript engine, and a data storage module for a web browser; in response to initiating a browsing session for a new website by a user, receiving a set of property values, a set of action values, and a set of consequence values associated with the browsing session for the new website from instrumented hooks embedded in the browser engine, the rendering engine, the networking module, the JavaScript engine, and the data storage module; determining, via a trained AI model, a score for the browsing session being associated with a website having a malicious component; and outputting the score, wherein the score is employed to prevent the user from selecting an actionable component in a rendered website.

In some embodiments, the method described herein further comprises outputting a notification indicating presence of an actionable component for a rendered website.

In some embodiments, the set of property values is associated with a compilation and execution of a script of the rendered website and includes at least one of an execution context of a running script as a top frame or a subframe, an execution context of the running script having a same origin frame or cross-origin frame, a type of script as an inline script in HTML, a type of script as a remote script file, a type of script as a dynamically generated script, an owner of the script being served by a first-party server, an owner of the script being served by a third-party server, a requestor being an HTML parser, and a requestor being from another script that is not an HTML parser.

In some embodiments, the set of action values is associated with an observed behavior exhibited by a script of the rendered website and includes at least one of a register event listener action having an event type associated with a keyboard, mouse, and/or hover, a register event listener action having an event target as a type of DOM element, an add timer callback action as a setTimeout, an add timer callback action as a setInterval, an add timer callback action as an interval, an insert DOM node action using an <a > inserted node type, an insert DOM node action using a <script> inserted node, an insert DOM node action using a <div> inserted node, a modify DOM node attribute, a modify DOM node attribute action using a “style” attribute, a modify DOM node attribute, a modify DOM node attribute action using a “href” attribute, a modify DOM node attribute, a modify DOM node attribute action using a “src” attribute, an open-new-window action using an URL for a new window, a render-window using a tab window from an open-new-window action, a render-window using a full window from an open-new-window action, an initiate navigation action with a URL of a navigation target, an initiate navigation action from a top frame, an initiate navigation action with a URL from an iframe, an initiate navigation action within a same-origin, an initiate navigation action by a client code, an initiate navigation action by the browser by user action, a send network request action via a URL of the request, a send network action via a script, a send network action via an image, a send network action via a document, and a send network action via a JavaScript object notation (Json).

In some embodiments, the set of consequence values is associated with an observed behavior of the browser after navigation from the rendered website and includes at least one of a number of redirected hops until landing at a destination page, a number of unique domains of the redirected hops, a redirect type being code-driven, and a redirect type being response-header-driven.

In some embodiments, the trained AI model was trained using a set of features populated using a web crawler, wherein the web crawler was configured to simulate user interactions with the respective website to trigger one or more JavaScript events.

In some embodiments, the trained AI model was trained using a set of features populated using a web crawler, wherein the web crawler was configured to create an in-memory graph where, after visiting each respective website, the graph is dumped into a disk and features are extracted based on a causality relationship of nodes for each website.

In some embodiments, the initiating the browsing session includes parsing, via an HTML parser, an HTML document to start rendering a page, wherein the parsing, constructing an in-memory graph, and updating the in-memory graph when a respective instrumented hook embedded in the browser engine is triggered.

In some embodiments, the initiating the browsing session includes concluding a feature vector before the browser commits to a new landing page to infer whether the navigation is related to a social engineering attack.

In another aspect, a non-transitory computer-readable medium is disclosed having instructions stored thereon, wherein execution of the instructions by a processor causes the processor to execute a user interface module, a browser engine, a rendering engine, a networking module, a JavaScript engine, and a data storage module for a web browser; in response to initiating a browsing session for a new website by a user, receive a set of property values, a set of action values, and a set of consequence values associated with the browsing session for the new website from instrumented hooks embedded in the browser engine, the rendering engine, the networking module, the JavaScript engine, and the data storage module; determine, via a trained AI model, a score for the browsing session being associated with a website having a malicious component; and output the score, wherein the score is employed to prevent the user from selecting an actionable component in a rendered website.

In some embodiments, execution of the instructions further causes the processor to output a notification indicating presence of an actionable component for a rendered website.

### BRIEF DESCRIPTION OF DRAWINGS

FIGS. 1A-1B each shows an example system for detecting and blocking social engineering advertisements (SE-ads) configured with browser-embedded instrumented hooks and a classifier (i.e., trained AI model) in accordance with an illustrative embodiment. FIG. 1A operates the browser-embedded instrumented hooks and classifier on a local web browser. FIG. 1B operates the browser-embedded instrumented hooks on a local browser and the classifier on a cloud infrastructure.

FIG. 2 shows an example operation flow for the exemplary method in accordance with an illustrative embodiment.

FIGS. 3A-3C show an example system configured with web action history graph construction operations. FIG. 3A shows an example detection system configured to prevent web-based social engineering attacks by detecting techniques used by social engineering advertisements (SE-ads). FIG. 3B shows an example Web Action History Graph (WAHG) highlighting SE-ad attacks on a webpage. FIG. 3C shows an example WAHG construction process using a navigation initiator as a JavaScript function or as an anchor tag.

FIGS. 4A-4E show the training dataset and performance of the exemplary system in detecting social engineering advertisements (SE-ads). FIG. 4A shows the SE-websites included in the training dataset. FIG. 4B shows the receiver operating characteristics (ROC) curve of the exemplary system. FIG. 4C shows the performance of models trained on different combinations of features to demonstrate feature importance in detecting SE-ads. FIG. 4D shows the runtime overhead induced on the page load by the exemplary system for the Tranco 1,000 websites. FIG. 4E shows the resource usage induced on the page load by the exemplary system.

FIG. 5A shows example social engineering advertisements (SE-ads).

FIG. 5B shows an example of how an ad network manipulates users to interact with SE-ads by including JavaScript (JS) code into a content-sharing website (i.e., ad publisher).

FIG. 5C shows the script snippets from Google Ads and AdSterra.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference was individually incorporated by reference.

### Example System

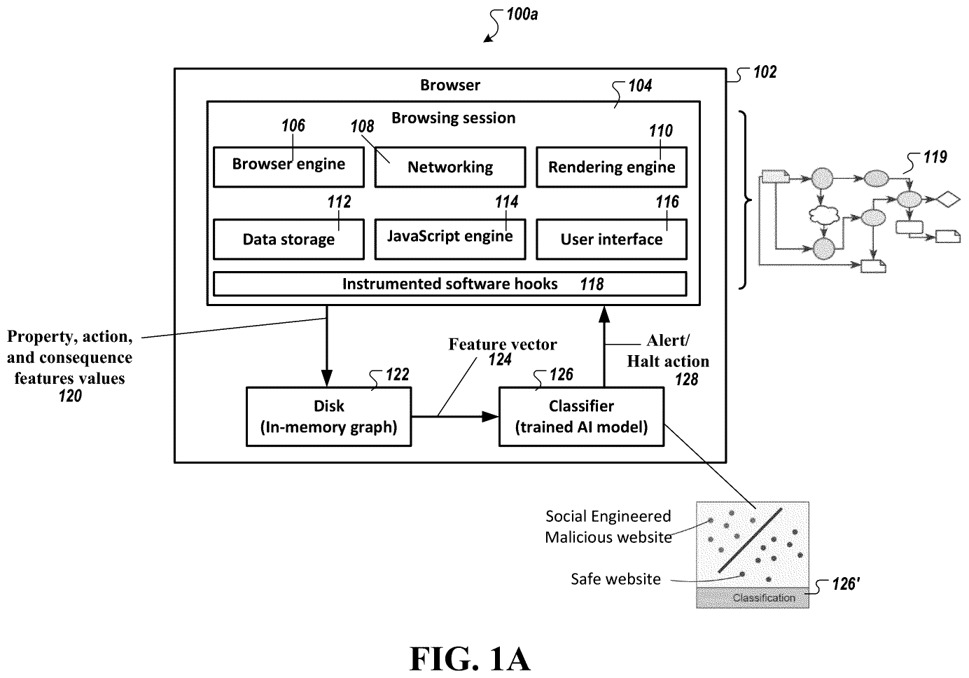

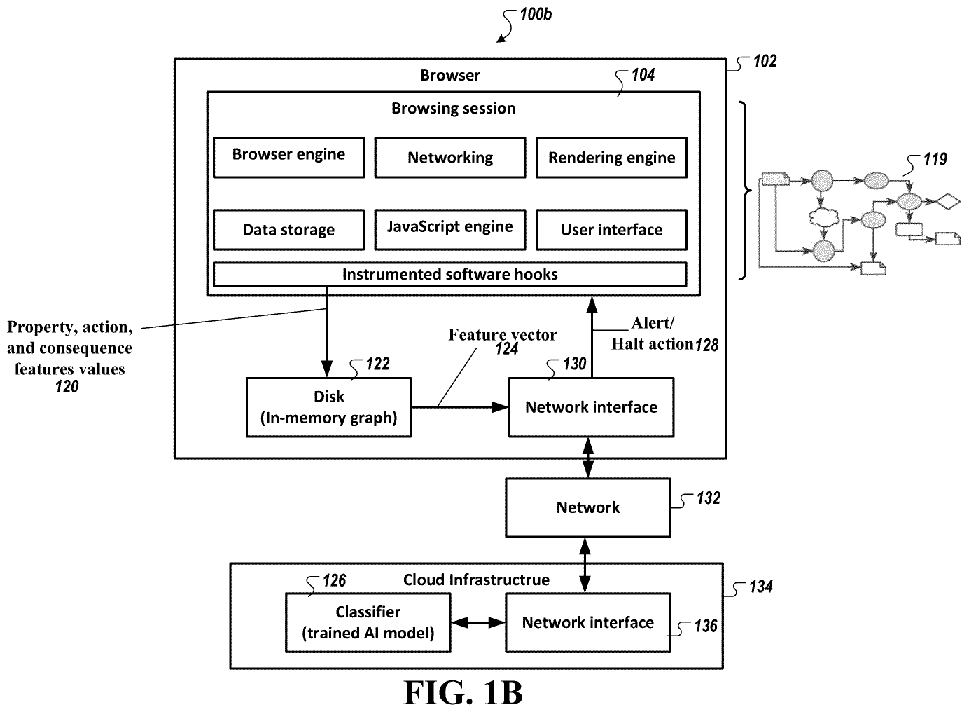

FIGS. 1A-1B each shows an example system 100 (shown as 100a, 100b) for detecting and blocking social engineering advertisements (SE-ads) configured with a browser-embedded instrumented hooks and a classifier (i.e., trained AI model) in accordance with an illustrative embodiment. FIG. 1A operates the browser-embedded instrumented hooks and classifier on a local web browser. FIG. 1B operates the browser-embedded instrumented hooks on a local browser and the classifier on a cloud infrastructure.

In the examples shown in FIGS. 1A-1B, the system 100a-100b includes the local web browser 102, wherein the browser 102 is configured with the disk 122 (shown as an in-memory graph) and the classifier 126 (i.e., trained AI model). The browser 102 initiates a browsing session 104 on which the browser 102 executes a browser engine 106, a networking module 108, a rendering engine 110, a data storage module 112, a JavaScript engine 114, and a user interface module 116. In response to initiating the browsing session 104 for a new website by a user, the web browser 102 receives property, action, and consequence feature values 120 (e.g., a set of property values, a set of action values, a set of consequence values) with the browsing session 104 for the new website from instrumented software hooks 118 embedded in the browser engine 106, the networking module 108, the rendering engine 110, the data storage module 112, the JavaScript engine 114, and the user interface module 116. The browsing session 104 of the web browser 102 then transmits the property, action, and consequence feature values 120 to the disk 122.

In the system 100a, as shown in FIG. 1A, the disk 122, coupled with the browsing session 104, receives the property, action, and consequence values 120 and transmits a feature vector 124, created by a web crawler (not shown), to the classifier 126 (i.e., trained AI model).

The classifier 126 (shown as 126′), coupled with the disk 122, receives the feature vector 124 and examines the feature vector 124 before the browser 102 commits to a new landing page to infer whether the navigation is related to a social engineering attack (i.e., navigation to a social-engineered malicious website) or related to a safe website. When the navigation is related to a social engineering attack, the classifier 126 determines a score for the SE-attack-related navigation and outputs the score as an “alert” or “halt action” message 128 to the browsing session 104 to prevent the user from selecting an actionable component in a rendered website.

The initiation of the browsing session 104 by the browser 102 may include parsing, via an HTML parser, an HTML document to start rendering a page, wherein the parsing, constructing an in-memory graph, and updating the in-memory graph when a respective instrumented hook 118 embedded in the browser engine is triggered.

The classifier 126 may be trained using the feature vector 124 (i.e., a set of features) populated by the crawler, wherein the web crawler may be configured to create an in-memory graph where, after visiting each website, the graph is dumped into the disk 122, and features are extracted based on a causality relationship 119 of nodes for each website to generate the feature vector 124. The web crawler may also be configured to simulate user interactions with the website to trigger one or more JavaScript events.

The set of property values in 120 may be associated with a compilation and execution of a script of the rendered website and includes at least one of an execution context of a running script as a top frame or a subframe, an execution context of the running script having a same origin frame or cross-origin frame, a type of script as an inline script in HTML, an owner of the script being served by a first-party server, an owner of the script being served by a third-party server, a requestor as an HTML parser, and a requestor being from another script that is not an HTML parser.

The set of action values in 120 may be associated with an observed behavior exhibited by a script of the rendered website and includes at least one of a register event listener action having an event type associated with a keyboard, mouse, and/or hover, a register event listener action having an event target as a type of DOM element, an add timer callback action as a setTimeout, an add timer callback action as a setInterval, an add timer callback action as an interval, an insert DOM node action using an <a > inserted node type, an insert DOM node action using a <script> inserted node, an insert DOM node action using a <div> inserted node, a modify DOM node attribute, a modify DOM node attribute action using a “style” attribute, a modify DOM node attribute, a modify DOM node attribute action using a “href” attribute, a modify DOM node attribute, a modify DOM node attribute action using a “src” attribute, an open-new-window action using a URL for a new window, a render-window using a tab window from an open-new-window action, a render-window using a full window from an open-new-window action, an initiate navigation action with a URL of a navigation target, an initiate navigation action from a top frame, an initiate navigation action with a URL from an iframe, an initiate navigation action within a same-origin, an initiate navigation action by a client code, an initiate navigation action by the browser by user action, a send network request action via a URL of the request, a send network action via a script, a send network action via an image, a send network action via a document, and a send network action via a JavaScript object notation (Json).

The set of consequence values in 120 may be associated with the observed behavior of the browser after navigation from the rendered website and includes at least one of a number of redirected hops until landing at a destination page, a number of unique domains of the redirected hops, a redirect type being code-driven, and a redirect type being response-header-driven.

In the system 100b, as shown in FIG. 1B, the disk 122 receives the property, action, and consequence values 120 from the browsing session 104 and transmits a feature vector 124 to a network interface 130. The network interface 130, operating on the browser 102, then transmits the feature vector 124, via a network 132, to a network interface 136. The network interface 136, operating on a cloud infrastructure 134, receives the feature vector 124 via the network 132 and forwards the feature vector 124 to the classifier 126 (i.e., trained AI model).

The classifier 126, operating on the cloud infrastructure 134 and coupled with the network interface 136, receives the feature vector 124 and examines the feature vector 124 before the browser 102 commits to a new landing page to infer whether the navigation is related to a social engineering attack (i.e., navigation to a social-engineered malicious website) or related to a safe website. When the navigation is related to a social engineering attack, the classifier 126 determines a score for the SE-attack-related navigation and outputs the score as an “alert” or “halt action” message 128, via a network route comprising the network interface 136, the network 132, and the network 130, to the browsing session 104 to prevent the user from selecting an actionable component in a rendered website.

### Example Method

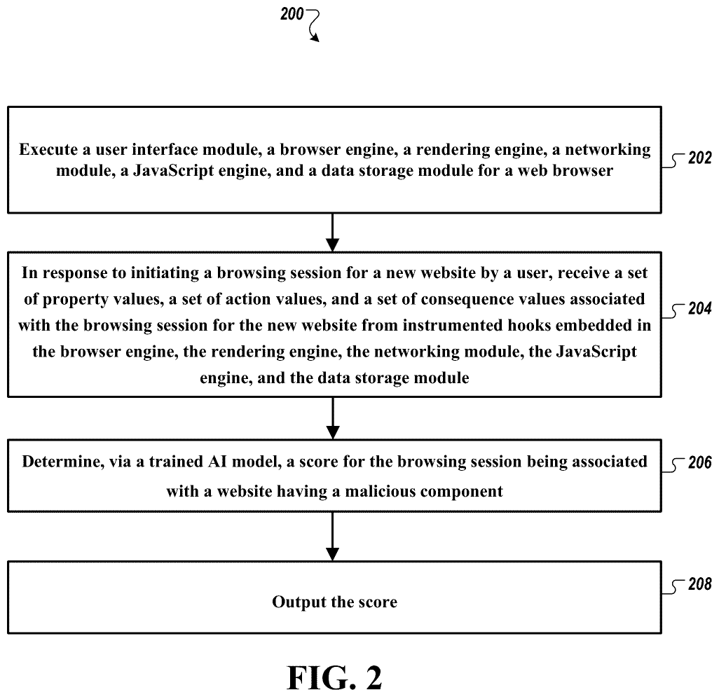

FIG. 2 shows an example operation flow 200 for the exemplary SE-ad detection method. As shown in FIG. 2, the exemplary method 200 includes four steps.

At step 202, the exemplary method 200 executes a user interface module, a browser engine, a rendering engine, a networking module, a JavaScript engine, and a data storage module for a web browser.

At step 204, in response to initiating a browsing session for a new website by a user, the exemplary method 200 receives a set of property values, a set of action values, and a set of consequence values associated with the browsing session for the new website from instrumented hooks embedded in the browser engine, the rendering engine, the networking module, the JavaScript engine, and the data storage module.

At step 206, the exemplary method 200 determines, via a trained AI model, a score for the browsing session being associated with a website having a malicious component.

At step 208, the exemplary method 200 outputs the score.

### Example Real-time SE-ad Detection System

The exemplary real-time detection system may identify Social Engineering Advertisements (SE-ads) and block navigation to potential social engineering Websites (SE-websites). At a high level, the exemplary system takes advantage of two intuitions: (1) SE-ads use tricks (e.g., clickjacking and social engineering) to lure users into interacting with strategically placed document object model (DOM) elements and triggering unwanted browser navigation; and (2) SE-ads navigate the user to malicious websites that host social engineering attacks (e.g., tech support scams, malicious downloads, etc.). Therefore, to detect SE-ads and block the subsequent events, the exemplary system monitors the user's browsing session and vets each navigation to determine if it may be related to an SE-ad. More specifically, during this vetting process, the exemplary system extracts features related to how this navigation is initiated and passes these features to its classification module. Finally, when the exemplary system determines this navigation is SE-ad related, the exemplary system presents an interstitial page to warn the user.

While prior approaches [7], [8], [11] focus on specific SE attack vectors, the exemplary system takes a more generic approach that relies on the causality of how users end up on SE-websites. Namely, the exemplary system detects web-based social engineering attacks (WSEAs) by detecting anomalous techniques used by SE-ads that intercept users' clicks by any means, which lead to websites that host SE attacks.

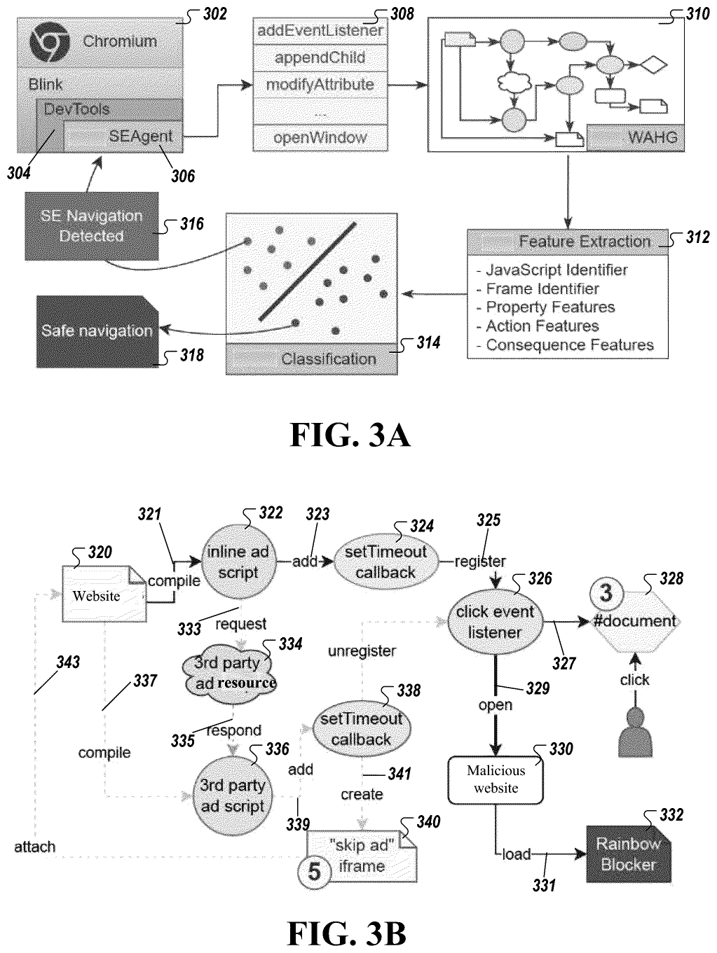

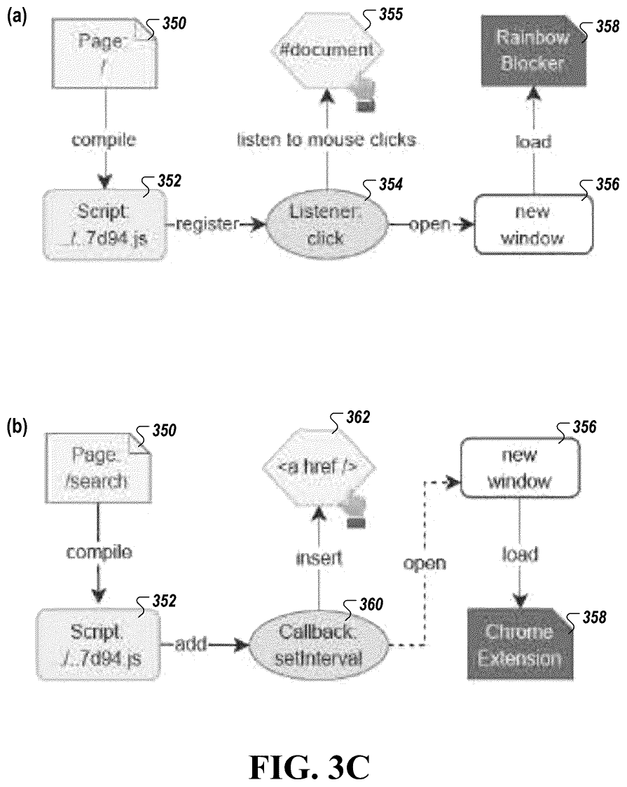

FIG. 3A shows an example detection system configured to prevent web-based social engineering attacks by detecting techniques used by Social Engineering advertisements (SE-ads). As shown in FIG. 3A, first, the exemplary system instruments Chromium 302 by extending the Chrome DevTools Protocol framework 304 (CDP) [35] with a new agent, Social-Engineering agent 306 (SEAgent). While a user is visiting a website, the SEAgent 306 collects JavaScript (JS) actions 308 (e.g., event listener registrations and DOM modifications) and sends them to a background daemon. The background daemon builds an in-memory graph representation 310 of the web page and its activities, which is known as a Web Action History Graph (WAHG).

While the exemplary system builds and updates the WAHG 310, it also extracts property features, action features, and consequence features about the page's JS code from the graph via a feature extraction operation 312. These features describe how these scripts are included, what contexts the scripts are running in, and what the scripts do on a web page. These features are passed to a classification module 314, which classifies the navigation as related to SE-ads (shown as 316) or benign (shown as 318).

Web action history graph. The Web Action History Graph (WAHG) is a graph-based representation of a web page. Nodes in the graph represent web objects (e.g., window, resource, DOM node, etc.), and edges represent causal relationships between objects. For example, when a script inserts a new DOM element into the DOM tree, an edge from the script to the element may be connected to the WAHG.

Table 1A shows the graph objects (i.e., nodes, web objects) of a web action history graph. Table 1B shows the relationships between the graph objects in the web action history graph.

TABLE 1A

| Object Type | Attributes |
|---|---|
| Frame | security_origin, url, is_page |
| Window | url |
| Resource | url, type |
| Script | url, is_isolated, frame_owner |
| Function | url, is_eval_or_new_function, location |
| DOM Node | tag_name, is_inserted_by_js |
| HTML Parser | frame_owner |

TABLE 1B

| Relationship | Example |
|---|---|
| Attached | Frame → Frame |
| Compiled by | Script → Frame |
| Created | Script/Function → Frame |
| Add event listener | Script/Function → Function |
| Listen to events | Function → DOM Node |
| Add callback function | Script/Function → Function |
| Navigated | Frame → Frame |
| Opened | Frame → Window |
| Load | Window → Frame |
| Request | Parser/Script/Function → Resource |
| Response | Resource → Parser/Script/Function |

FIG. 3B shows an example Web Action History Graph (WAHG) highlighting SE-ad attacks on a webpage. In FIG. 3B, the first SE-ad is launched by an inline script 322 on a website 320 and is represented by the set of nodes connected by the solid edges. The first SE-ad attack begins when the website 320 compiles the inline ad script 322. This step, referred to as 321, represents a “Compiled by” relationship (shown in Table 1B) between the script 322 and the frame 320.

Then, the inline script 322 initiates the deployment of the SE-ad by scheduling a delayed callback 324 to be executed using “setTimeout.” This step, referred to as 323, represents an “Add callback function” relationship (shown in Table 1B) between the script 322 and the function 324.

When the callback 324 is executed, the callback 324 adds a new mouse event listener 326 onto the “#document” element 328, which consequently covers the whole viewport, hijacking any mouse clicks. Step 325, wherein the callback 324 adds the event listener 326, represents an “Add event listener” relationship (shown in Table 1B) between the function 324 and the function 326. The step 327, wherein the event listener 326 is added on the “#document” element 328 and listens to user clicks, represents a “Listen to event” relationship (shown in Table 1B) between the function 326 and the DOM node 328.

When there is a mouse click, the mouse event listener 326 on “#document” 328 is fired and redirects the browser window 330 to a malicious website. This step, referred to as 329, represents an “Opened” relationship between the function 326 and the window 330.

The malicious website on the window 330 then loads an unauthorized frame 332 to download a software or an extension (e.g., Rainbow blocker). This step, referred to as 331, represents a “Load” relationship between the window 330 and the frame 332.

The second SE-ad attack is shown by the dashed path, which is initiated by the same inline script 332 but with a different deployment technique. More specifically, the second SE-ad attack begins when the inline script 332 requests a third-party ad script 336 from a third-party resource 334. This step 333 represents a “Request” relationship between script 322 and the third-party resource 334.

Then, the third-party resource 334 responds to the request 333 by injecting the third-party ad script 336 into the website 320. This step, referred to as 335, represents a “Response” relationship (shown in Table 1B) between the resource 334 and the script 322.

After being injected into the website 320, the third-party ad script 336 is then compiled by the website 320. This step, referred to as 337, represents a “Compiled by” relationship between the script 336 and the frame 320.

The third-party ad script 336 also uses “setTimeout” callback 338 (via “Add callback function” relationship 339) to create an inline frame (iframe) 340 (via “Created” relationship 341) and insert it onto the website (via “Attached” relationship 343). If the “Skip Ad” button, rendered in the iframe 340, is clicked, a malicious download may also begin. This example demonstrates the fine-grained details related to a web page that is embedded into the WAHG.

Social-engineering agent module. The Social-Engineering Agent (SEAgent) module resides within the browser to emit event logs for constructing the WAHG. To minimize the footprint in the browser, the SEAgent module may be implemented on top of the Chrome DevTool's Protocol (CDP) [35], which can be easily updated and maintained.

CDP is a debugging tool that assists web developers with UI development. In addition to debugging a website, CDP can also be used to analyze the website for security and privacy purposes. More specifically, CDP implements several “domains” where each domain has a set of APIs and events related to a particular aspect of a web application (e.g., DOM, Network, or DOMDebug). Internally, each domain relies on a backend, “Inspector Agent,” that encapsulates the necessary instrumentation to support the domain. For example, the DOM domain provides events for DOM modifications, and the DOMDebug domain exposes an API to collect current event listeners. Current state-of-the-art CDP domains cannot support real-time information collection for some cases. For example, the DOMDebugger “.getEventListeners” API collects current event listeners on the DOM at the query time. This API should be called frequently to capture every registered and removed listener, which is cumbersome and risky because a malicious listener may be removed when this API is called. Moreover, the Debugger domain does not implement event hooks for the JS executing stack, which may be essential for JS action attribution.

To meet the real-time requirement, the SEAgent is implemented with less than 800 lines of C++ code. SEAgent is a plug-n-play component to the current state-of-the-art CDP, which means it is easy to update and maintain with browser updates. SEAgent implements four types of hooks to collect JS actions for constructing the WAHG in real-time. Table 2 shows the example hooks (e.g., DOM, Page, Network, Script) and their details.

TABLE 2

| Hooks | Description | Locations |
|---|---|---|
| DOM | Record DOM activities (e.g., DOM manipulation, etc.) | Node creation, insertion, and |
| | Attribute the operation to a JS function. | removal |
| | | Node attributes modification |
| Page | Record frame activities (e.g., iframe creation and | Iframe attaches and detaches |
| | deletion, frame navigation, opening new tabs, etc.) | Frame navigation/Opening |
| | Attribute the operation to a JS function. | new windows |
| Network | Record network activities (e.g., what resources are | Network requests |
| | being requested, who are responsible for these | Network responses |
| | requests, etc.) | |
| Script | Record JavaScript activities (e.g., what scripts are | Script compilation, execution |
| | compiled and executed, what user callbacks are | Function invocation |
| | added, what event listeners are registered, etc.) | Add user callbacks/event |
| | | listeners |

Whenever a hooked API is called, SEAgent emits an event immediately. For example, the instrumentation in event listener registration collects the “event_target,” “event,” and the listener “function” whenever a script or function calls “addEventListner” to meet the real-time requirement for feature collection.

Web Action History Graph (WAHG) construction. The exemplary system uses the event logs collected by the SEAgent to construct the WAHG in real-time progressively. FIG. 3C shows an example WAHG construction process using a navigation initiator as a JavaScript function or as an anchor tag (e.g., href).

The exemplary system parses every event and translates the results into nodes and edges. There are two important attribution steps that the exemplary system performs: (1) JS attribution, which associates DOM events to a responsible JS file, and (2) navigation initiator attribution, which determines which script requests the navigation such that the exemplary system only needs to inspect paths to this script node on the WAHG instead of inspecting all the script nodes.

During the JavaScript attribution, the exemplary system needs to attribute all DOM events to the accountable script. To do so, for each interaction and event, the exemplary system attributes the event to the current executing JS function. For instance, as shown in subpanel (a), when the script “../..7d94.js” 352 inserts an event listener 354 onto the page 350, the exemplary system connects the script 352 to the listener 354. This approach addresses most cases for finding the responsible JS file, However, the two global JS functions, “eval” and “Function”, pose challenges when the exemplary system tries to attribute events to the correct functions or scripts. For example, when an external script loads, it invokes “eval” to evaluate a JS code snippet. This process requires compiling the snippet and generating a new script object, but this snippet may not have a valid URL. In these cases, the exemplary system may assign events caused by the snippet to its caller's URL. The same method may be applicable to the “Function” API as it works similarly to “eval”.

There are two types of navigation initiators: a script initiator (shown in subpanel a) or a user's action initiator (e.g., clicking a link, typing in the address bar) (shown in subpanel b). Finding the initiator of a navigation event helps reduce the analysis space by only having to analyze scripts and events related to the navigation, which leads the users to the websites under the attacker's control. Subpanel (a) presents a JS function initiator (i.e., user's action initiator), the click listener 354, which opens a new page 356 upon a mouse click on any “#document” elements 355. By analyzing the WAHG, the exemplary system can locate the responsible script that may lead to a SE-website 358.

Not all navigation events are initiated by JS code directly. In subpanel (b), an anchor tag 362 is inserted by a timer callback function 360. When the user clicks on the link, it opens a new window 356. Based solely on the information on this path, the exemplary system cannot determine what code is responsible for the navigation. To handle these cases, the exemplary system learns what the “href” attribute is assigned to or updated for all the anchor nodes (e.g., 362). The exemplary system connects the JS function that modifies or updates the anchor node to the new window by matching their URLs.

Web features. The exemplary platform extracts web features (e.g., property action, consequence) in real-time and uses the features to learn the characteristics of malicious and benign web scripts.

Table 3 shows example features (e.g., property, action, consequence) used by the exemplary system to learn the characteristics of malicious and benign scripts.

TABLE 3

| Group | Features |
|---|---|
| Property | execution context (first-party or third-party frame), |
| features | script type (inline, remote file, eval, or function), |
| | owner (first party or third party), |
| | requestor (HTML parser or another script), and |
| | requestor's properties. |
| Actions | register event listeners (event_type, event_target), |
| features | add timer callbacks (setTimeout, setInterval), |
| | insert DOM nodes (node_type), |
| | open new windows (url, target), |
| | initiate navigation (url, iframe, origin, client_redirect, |
| | browser_initiated), |
| | modify DOM node attributes (attributes), and |
| | send network requests (resoure_type, url). |
| Consequence | Number of redirect hops, |
| features | number of unique domains, and |
| | redirect type (JS-driven, response-header-driven). |

As shown in Table 3, the first group (i.e., property features) introduces the script's properties, the second group (i.e., action features) describes the script's behaviors, and the last group (i.e., consequence features) contains redirect information.

Property features target the properties of a script, including how the script is included in a web page, who owns the script, and the context in which it is running. The exemplary system determines the property features when a script is compiled and executed. When the script is inserted into the web page by another script, the exemplary system also adds the requestor's properties. First-party scripts are usually included by the website operator, which implies they can be trusted, whereas third-party scripts (e.g., ad scripts from ad networks) are unverified and should not be trusted. Legitimate ad scripts follow the FTC rules [27] to inject ads, for example, by isolating their ad contents inside an iframe. In contrast, SE-ad scripts are strongly motivated to elicit user clicks by any means. Therefore, the exemplary system uses the feature group to learn whether a suspicious action can be trusted.

Action features represent the behaviors exhibited by a script on the web page. These actions are primarily related to click hijacking, including registering event listeners, adding large hyperlinks, and injecting visually deceptive elements. Each action becomes an edge in the WAHG. The exemplary system then extracts these features from both the node's and the edge's properties. For instance, the register event listeners feature considers the “event_type” of the edge and “event_target” of the target node. More specifically, a JS function registers an event listener that listens to mouse events on a specific DOM element. This DOM element is the “event_target.” The exemplary system checks whether this DOM element is a JS-inserted DOM Node or a built-in large element (e.g., #document, body). For actions involved in network requests, such as opening new windows, attaching iframe, initiating same-tab navigation, and sending network requests, the exemplary system may examine the URL to determine where the resources are from. This feature group helps the exemplary system learn to separate malicious activities from benign ones. For example, appending a transparent hyperlink covering the whole viewport is more suspicious than adding a visible iframe to load content.

Consequence features describe what happens after the navigation. The exemplary system extracts the URLs in the redirect chain and collects the number of unique domains. The exemplary system also checks whether the redirect is initiated by JS or an HTTP response header. The exemplary system considers the redirect chain between the first page and the eventual landing page because the window directly opened by clicking an ad usually is not the eventual landing page [9], [38]. Usually, ad networks need to determine what ad to present by collecting the user's cookies before deciding where to send the user. Unlike clicking on ads, clicking on a link to an article usually directly opens the article without any redirects because the website knows where the user is heading. Therefore, redirects between the opening action and the final landing action are good indicators of ads. This is useful for the exemplary system to determine whether a newly opened tab is for ads. Moreover, analyzing these consequence features is mandatory because popular websites may also deploy techniques to intercept the users' clicks for benign purposes [36], and merely relying on the features of the current page can cause high false positives [13].

To conclude, the exemplary system's primary goal is to detect navigation made by clicking benign ads, links, or SE-ads. Simply put, benign ads follow FTC rules, which create iframes that do not intercept users' clicks; anchor links usually do not need to redirect the users multiple times; and SE-ads steal users' clicks by any means and redirect the users to SE-websites.

Real-time feature extraction. Unlike prior approaches [9], [37] that collect features offline, the exemplary system may extract features while the user is browsing so that the exemplary system can timely detect and block SE-related navigation. This process may be asynchronous to the browser rendering process, so collecting features for each event may not impact the user experience. For instance, when a script registers an event listener, the exemplary system creates or finds the script node, creates or finds the function node (the event listener), and creates or finds the event target node (e.g., a DOM node). Then, the exemplary system updates the WAHG by connecting them. Meanwhile, the exemplary system updates the action features of this script for adding a listener.

When a navigation event is received, the exemplary system may only need to update the WAHG one last time to insert the target frame node and connect the frame to the script or function node, which may initiate the navigation. The initiator then may become the entry point for backtracking on the WAHG. Taking the example in FIG. 3B, when the user clicks the “#document,” the event listener is triggered to open a new window. At this point, the exemplary system may have already learned that the in-line script adds a “setTimeout,” which registers the event listener. As the features may already be stored in memory for the in-line script, the exemplary system only needs to update the features by adding that the script also opens a new window. Therefore, the exemplary system does not need to make expensive queries to traverse the WAHG for feature collection at the last point. Then, the exemplary system may translate these features into a feature vector that captures the actions done by this script under its owner frame's context and pass down to the classifier.

Classification module (i.e., classifier). The exemplary system also may employ a classification module (i.e., classifier). When a navigation event is about to occur, the extracted features may be passed to the classification module, which may classify the navigation as SE-ad-related or benign. When the navigation is determined to be SE-ad-related, the exemplary system may block the navigation to prevent the user from being directed to the SE attack. Internally, the exemplary system uses a random forest [39] classifier for classification. The random forest may be configured as an ensemble of a plurality of decision trees (e.g., 100 decision trees), with each decision tree using √\sqrt{N} features, where N is the total number of features.

When visiting a website, the SEAgent continuously sends events to the post-processing daemon, which builds the WAHG, extracts the features, and runs the classifier. When navigation is scheduled, the features, except for the consequence ones, are sent to the classifier. When the navigation is about to commit, the daemon receives the updated consequence features and reruns the classifier before the landing page commits. When the classifier classifies a navigation request as malicious, the SEAgent inserts an interstitial warning page to make the user aware of the dangers ahead. The exemplary system may employ at least one classification module trained with and without consequences features.

### Experimental Results and Additional Examples

A study was conducted to develop and evaluate the exemplary system and method for real-time detection of social engineering attacks and advertisements. The study collected the datasets and evaluated the exemplary system and state-of-the-art systems running on the collected datasets.

### Experimental Setup

A study was conducted to develop and evaluate an online system (TRIDENT) for detecting and blocking social engineering ads. The study showed that TRIDENT could effectively detect SE-ads and block the consequent navigation to social engineering websites with an accuracy of 92.63%, which outperforms the state-of-the-art generic adblocking tools by more than 10%. Finally, TRIDENT's runtime performance is extremely low and only has a 2.13% median increase on the page load time on websites in the Tranco 1 k list.

Data source. In the study, the data collection process relied on publicwww.com (P.W.) [40], a popular source code search engine, to collect scripts that may deploy SE-ads. The study obtained over 100,000 ad publisher websites by searching JS code snippets on P.W. by following the approaches used in the study [9]. These JS code snippets were obtained by analyzing websites, which were open-sourced in the study [9], and websites the study encountered by searching for free content-sharing websites, which preferred to include low-tier ad networks as suggested by prior research [12].

Crawler design. Unlike previous studies [19], [33], [41] that only crawled the Internet by loading the home page, the study required a crawler to interact with as many SE-ads as possible. To achieve this, the study built the crawler on top of Puppeteer [42] to simulate users' interactions with web pages and developed a clicking strategy conducive to triggering navigation. First, the study collected anchor elements that point to a different origin and placed them in an anchor node pool. Additionally, the study collected elements with mouse listeners in a mouse event pool. Because large elements had a higher chance of being clicked, the study sorted the DOM nodes in descending order of the element's bounding box size to prioritize the elements that were most likely to capture a real user's clicks. Then, the crawler clicked the elements in these pools one by one. If a click triggers navigation, the crawler took a screenshot of the navigated page.

The study deployed the crawlers in 20 docker containers simulating users' interactions with websites from October 2021 to January 2022 to collect training data and in October 2022 to collect data for examining the exemplary system's robustness. The study used these two datasets to evaluate the exemplary system's accuracy, investigate the exemplary system's false positives and false negatives, and compare the exemplary system with the state-of-the-art tool.

Ground truth and dataset cleaning. The study collected ground truth for the datasets and then cleaned and balanced the datasets.

Labeling. Previous studies [19], [41] relied on EasyList and EasyPrivacy [30] as ground truth to label ads-related URLs. Unfortunately, these lists focused on generic ads. Using these lists as the ground truth may make the exemplary system target generic ads, rather than SE-ads. To identify the ground truth in the datasets, the study developed semi-automated methods as the following to identify whether navigation lands on a malicious (SE) website.

Table 4 shows the semi-automated methods to identify whether navigation lands on SE-ads-related websites.

TABLE 4

| Labeling Method | Description |
|---|---|
| L1: Landing page | During crawling, when a new tab was open, or cross-origin |
| screenshots clustering | navigation occurred, the crawler took a screenshot of it. |
| | Following the methodology in the study [9], the study used a |
| | database scan (DBScan) on the perceptual hashes [43] of those |
| | screenshots to cluster them. Then, the study reviewed each cluster |
| | to visually identify whether a landing page is an SE website. If it |
| | is, the study labeled this navigation malicious. |
| L2: Categorical BlockList, | The study chose three additional services for identifying whether |
| Google Safe Browsing, | a website is malicious or not: a categorical BlockList [31] on |
| and VirusTotal. | GitHub, which was popular in the community and was updated |
| | frequently, Google Safe Browsing (GSB) [21], and VirusTotal |
| | (VT) [20]. The study considered a URL malicious if it fell in the |
| | buckets of Malware, Scam, Abuse, Phishing, and Fraud in the |
| | BlockList, was determined unsafe by GSB, or was flagged out by |
| | at least one of the engines in VirusTotal. Then, the study fed all |
| | landing page URLs and the URLs in the redirect chain to these |
| | three services to label them automatically. If a page's URL was |
| | labeled malicious, the study marked this navigation event as |
| | malicious. |

Then, the study labeled a navigation event malicious when either of the two labeling methods said it was malicious. Although these two labeling methods may mislabel some examples due to the imperfection of the chosen block lists and image clustering algorithm, they make the labeling process much more efficient for a large dataset. Therefore, the study used semi-auto-labeled ground truth to train the exemplary system.

Ground truth. In total, the study obtained 258,008 navigation events initiated by JS code. Using those two labeling methods, the study identified 1,479 navigation events resulting in SE attacks. The study obtained more than a million JS files, but most did not demonstrate behaviors related to the intended features, so the study excluded them from the ground truth.

Table 5 shows the statistics of the training dataset (i.e., ground truth).

TABLE 5

| | | Number | |
|---|---|---|---|
| | Number of | of SE- | % |
| | navigation | websites | of SE |
| Ad network | events | landed | attacks |
| Unknown | 119,391 | 438 | 0.37% |
| AdSterra | 1,247 | 350 | 28.07% |
| PopCash | 1,085 | 267 | 24.61% |
| _cdn.com | 559 | 141 | 25.22% |
| liked/Nexstar | 236 | 105 | 44.49% |
| Revenue Hits | 276 | 41 | 14.86% |
| cdn._.xyz | 77 | 36 | 46.75% |
| whos.amung.us | 29 | 29 | 100.00% |
| Zaro | 25 | 16 | 64.00% |
| (Persian specific) | | | |
| AdMaven | 324 | 13 | 4.01% |
| OnClasry | 20 | 12 | 60.00% |
| Propeller | 4 | 4 | 100.00% |
| AdExtrem | 21 | 3 | 14.29% |
| AdFly | 61 | 3 | 4.91% |
| AddThis | 5,552 | 0 | 0.00% |
| Google Ads | 66,677 | 0 | 0.00% |
| AdGebra | 331 | 0 | 0.00% |
| AdPartner | 93 | 0 | 0.00% |
| Amazon Ads | 24 | 0 | 0.00% |
| Facebook Ads | 13,983 | 0 | 0.00% |
| Infolinks | 15,162 | 0 | 0.00% |
| Mgid | 6,290 | 0 | 0.00% |
| PopAds | 1,087 | 0 | 0.00% |
| Rekmob | 248 | 0 | 0.00% |
| ShareThis | 17,973 | 0 | 0.00% |
| TeckAd | 22 | 0 | 0.00% |
| Twitter | 6,549 | 0 | 0.00% |
| Total | 258,008 | 1,479 | 0.05% |

As shown in Table 5, the ground truth covered more than ten low-tier ad networks (e.g., AdSterra, PopCash, etc.) and major top-tier ad networks (e.g., Google, Facebook, etc.). The study did not identify the brands of some ad networks. Therefore, if their domain(s) had a pattern, the study grouped them, such as cdn.com and cdn.__.xyz, where the blanks were random strings. Otherwise, they were labeled “Unknown”. Some low-tier ad networks (e.g., “PopAds”) were known to distribute SE-ads [9], [37]. However, the study did not find positive samples from the training dataset for these ad networks. After investigation, the study found that most navigation went to adult or benign websites (e.g., yahoo.com) due to cloaking. These adult websites did not show SE attacks during data collection.

Table 6 shows the types of SE attacks discovered by the labeling methods in this ground truth dataset.

TABLE 6

| | | Number | Number |
|---|---|---|---|
| | Number | labeled | labeled |
| | of SE | by L1 | by L2 |
| SE attacks | attacks | method | method |
| Unwanted-software | 857 | 817 | 539 |
| Download | | | |
| Dating Scam | 222 | 204 | 48 |
| Reward/Lottery | 177 | 156 | 92 |
| Scam | | | |
| Push notification | 148 | 148 | 25 |
| Scareware | 51 | 29 | 42 |
| Tech support scam | 24 | 20 | 13 |

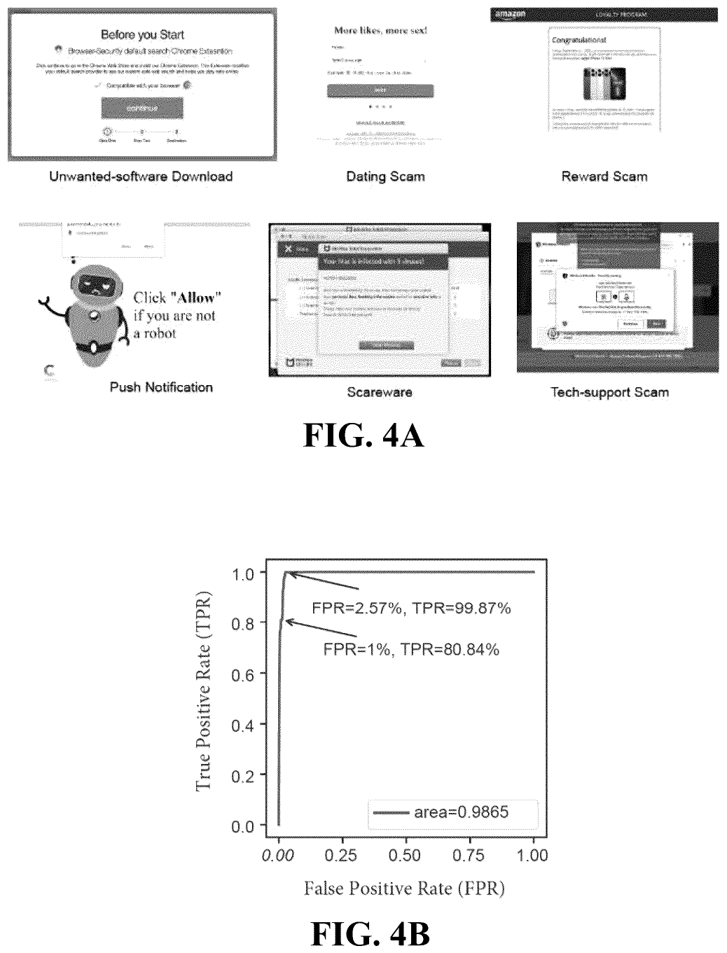

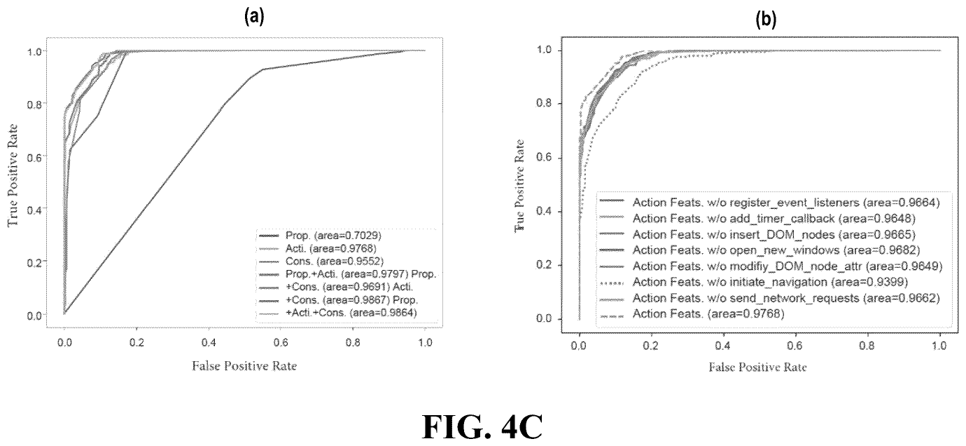

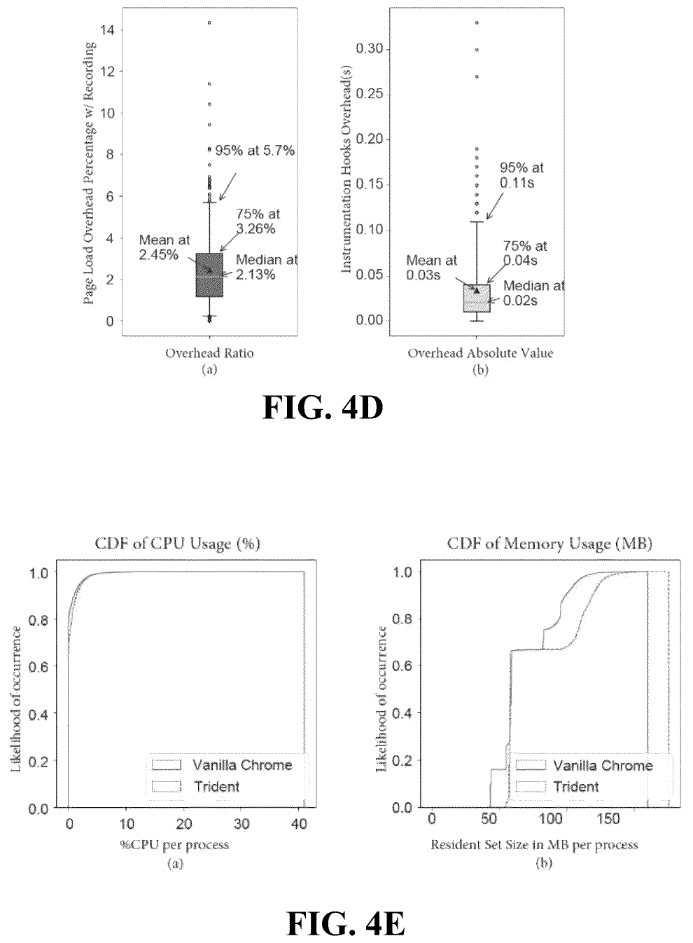

The study categorized those SE attacks based on the screenshots of the landing pages obtained by the crawlers. As shown in Table 6, there were six categories of SE attacks in total. FIG. 4A shows the SE-websites included in the training dataset.

Dataset cleaning. The study found that the training dataset was heavily imbalanced after labeling. There were two problems in the dataset: (1) the data was heavily imbalanced between classes, and (2) the data was imbalanced within the negative class (e.g., more scripts for rendering first-party content than scripts for injecting third-party ads). This was expected because benign scripts were ubiquitous. Training the exemplary system directly on this imbalanced dataset may produce a poor model.

There may be two strategies to overcome the imbalanced dataset problem: (1) over-sample the minor (malicious/positive) class or (2) under-sample the majority (benign/negative) class. To address the dataset problems, the study decided to under-sample the negative class as recommended by the state-of-the-art techniques [44], [45] to reduce the false-negative rate so that the exemplary system may detect SE-ads as accurately as possible.

Additionally, the study removed “silent” scripts that did not invoke any DOM APIs of interest and under-sampled the same number of positive classes from the negative class, which addressed the first problem. To address the second problem, the study analyzed the distribution of the features. Table 7 shows the navigation events made by benign and malicious scripts in the training dataset.

TABLE 7

| | New-tab (NT) | Same-tab (ST) |
|---|---|---|
| Class label | navigation | navigation |
| Malicious | 1,358 | 121 |
| Benign | 5,726 | 250,803 |

As shown in Table 7, benign scripts tended to navigate the users in the same tab. In contrast, the malicious scripts preferred to open new windows. Random sampling from the benign class yielded many same-tab navigation entries, making a performant classifier. However, this classifier may not generalize to websites that open windows in new tabs, which were data points near the classification border. Therefore, the study needed to choose more samples near this border, in this case, more entries in the new-tab navigation from the benign class. After analyzing the distribution of benign navigation events, the study chose 50% from the NT entries and 50% from the ST ones.

System Performance. The study evaluated the exemplary system using 10-fold cross-validation on the training dataset and reported the average accuracy. The study also examined the disagreement between the exemplary system and the ground truth data.

Accuracy. Table 8 shows the system accuracy with different methods of under-sampling the majority negative class.

TABLE 8

| New-tab | Same-tab | | | | F-1 |
|---|---|---|---|---|---|
| navigation | navigation | Accuracy | Precision | Recall | score |
| 100% | 0% | 87.76% | 86.69% | 89.31% | 87.98% |
| 90% | 10% | 88.30% | 86.09% | 91.68% | 88.80% |
| 50% | 50% | 92.63% | 90.63% | 96.28% | 93.37% |
| 0% | 100% | 99.76% | 99.78% | 99.43% | 99.60% |

| | | | | |
|---|---|---|---|---|
| Random sampling | 99.34% | 99.14% | 99.59% | 98.17% |
| No sampling | 97.69% | 89.71% | 76.39% | 82.52% |

First, the study trained the exemplary system with the raw imbalanced dataset (no sampling), which reported good accuracy but bad precision and recall, as shown in Table 8. Next, to improve the performance, the study balanced the dataset with random sampling.

As shown in Table 8, the more Same-tab Navigation (STN) entries the study sampled, the better the exemplary system performed, but the exemplary system lacked generality. When the study trained the exemplary system with (New-tab Navigation) NTN benign samples (all benign data points near the borderline), the accuracy dropped to 87.76%. Although the exemplary system had the lowest accuracy, this situation (each navigation opened a new tab) was implausible. As shown in Table 6, 97.77% of the navigation events happened in the same tab for the benign class. Therefore, to be conservative and include a good number of data points near the borderline from the benign class, the study decided to use 50% of the NTN entries and 50% of the STN entries for the benign samples to balance the dataset.

With this balanced training dataset, the exemplary system detected SE-ads-related navigation with 92.63% accuracy, 90.63% precision, 96.28% recall, and 93.37% F-1 score.

The exemplary system was configured to detect and block navigation initiated by SE-ads, not to block normal ads and harm the user experience. Therefore, the study tested the exemplary system on popular websites from the Tranco Top 1,000 list. In addition to the auto-crawling process, the study also collected data from 10 popular news, e-commerce websites, and social platforms (e.g., NYTimes, Washington Post, CNN, Forbes, Best Buy, Newegg, eBay, Twitter, Facebook, Reddit) by explicitly interacting with online ads and links.

In total, the study obtained 109,744 script-frame combinations. However, the study only found 78 navigation events initiated by JS. When labeling these 78 events, the study only found one website (yts.mx, ranked at 981/1,000 as of writing) served SE-ads and redirected to a SE-website. Next, the study fed this labeled data into the exemplary system and achieved 100% accuracy, which means the exemplary system allowed navigation made by interacting with normal ads and links and blocked the navigation initiated by the SE-ads served on yts.mx.

False positives and false negatives. The study analyzed the false positives (FPs) and false negatives (FNs) of the exemplary system. The study reused the dataset collected for the Tranco top 1,000 list and crawled 1,000 websites from ad publisher website lists. In total, the study collected 14,045 navigation events made by JS code. These navigation events involved 3,611 unique scripts and 5,823 unique web pages crawled from the 2,000 websites. The study first tested this dataset on the original model using the semi-auto labeling methods (shown in Table 4) and obtained a false positive rate of 5.86% (827 FPs). After manual investigation, the study discovered 477 mislabeled entries, which were primarily from adult websites, and corrected the labels. Finally, the study obtained 763 positive samples and 13,283 negative samples. These samples yielded a false positive rate of 2.57% and a false negative rate of 0.13% on the original model.

Table 9 shows the statistics of the positive class for the testing dataset. The negative class was omitted for brevity.

TABLE 9

| | | | Number |
|---|---|---|---|
| | Number of | Number | of SE |
| | navigation | of SE | attacks |
| Ad network | events | attacks | detected |
| AdSterra | 1,519 | 511 | 560 |
| Others | 8,793 | 151 | 297 |
| PopCash | 916 | 76 | 76 |
| realsrv | 129 | 16 | 33 |
| _cdn.com | 156 | 4 | 30 |
| PopAds | 596 | 2 | 2 |
| PopMyAds | 349 | 2 | 4 |
| AdMaven | 62 | 1 | 6 |

As shown in Table 9, the exemplary system detected all navigation to SE-websites initiated by at least seven low-tier ad networks. The study also found that the exemplary system detected “PopAds” and “PopMyAds” that were known to distribute SE-ads [9], [37]. However, they did not show any SE-websites when the study was collecting the ground truth. The exemplary system detected them when they took the study's crawlers to SE-websites.

The exemplary system achieved a 2.57% false positive rate after correcting the labels. After looking at these false positives, the study identified three types. The study examined each type and developed corresponding mitigation methods.

In the first type, the ad script injected DOM elements into the websites for benign purposes. For example, AddThis [46] accounted for 26% of the false positives. This ad network primarily injected clickable DOM elements into web pages. By clicking those elements, the user can share the website with others by posting a message on Twitter, Google+, or Facebook. This type of false positive did not have a pattern. Some of them were close to the decision boundary, and some were not.

In the second type, the ad script injected SE-ads, but interacting with the SE-ads took the user to normal advertiser websites directly. For example, absoluteroute.com accounted for 8.8% of the false positives. The ad script from this domain injected invisible overlays but took the crawlers to normal advertiser websites without redirection, e.g., worldofwarships.com based on the crawling records. These data entries were close to the classifier's decision boundary, with an average probability of 66.79% being positive.

In the third type, the ad scripts injected SE-ads, and interacting with the SE-ads led to adult websites. In the auto-labeling and manual labeling review processes, the study did not find those adult websites launching social engineering attacks immediately. However, those adult websites tracked users and can launch sophisticated attacks. This type of false positive was far from the decision boundary because the ad scripts did inject SE-ads and redirected users multiple times and the exemplary system determined they were SE-ads-related navigation. The only difference was that the landing page did not show social engineering attacks immediately. Note that the study found some mislabeled adult websites during the manual labeling review, but these false positives were not.

FIG. 4B shows the receiver operating characteristics (ROC) curve and highlights the true positive rate (TPR) at a false positive rate (FPR) of 1% and a false positive rate (FPR) of 2.57%. For a practical deployment, setting the detection threshold to achieve a TPR of 99.87% at an FPR of 2.57% may offer a better trade-off. The main reason was that the baseline for computing the false positives consisted only of navigation events that were initiated by JS. Navigation events initiated by JS were relatively rare; the study only found 78 navigation events initiated by JS out of thousands of instances. Therefore, the classifier of the exemplary system was rarely invoked, and only a small fraction of those rare events resulted in a potential false positive (i.e., an erroneously blocked navigation). Furthermore, to further improve the exemplary system, by reducing the FPR, the study used a whitelist-based approach to avoid incorrectly blocking trusted ad networks, e.g., AddThis, to reduce the first type of FP. This whitelist was configurable, allowing the user to decide what to include.

The exemplary system found one false negative, which converted to 0.13% false negative rate. The adult website hentaibedta.net embedded malicious links in its first-party content. Specifically, it included ad images that pointed to an external website (ouo.io/QqJgfz). During the investigation, this external website eventually landed the user on a malicious browser extension downloading page and two reward scam pages. The SE-ads on the adult site were injected by the first-party script and behaved as if they were the first-party content. Although the exemplary system failed to detect the script, this type of ad script may be considered out of scope as the exemplary system focused on ad networks that distributed malicious ad scripts at scale. If the study changed its property to a third party, the exemplary system can detect the navigation initiated by this script.

System feature importance and robustness. The study assessed the classifier (i.e., classification module) of the exemplary system by analyzing its feature importance in detecting SE-ads. Additionally, the study analyzed the robustness of the exemplary system against concept drift [47] and evading techniques.

Feature importance. The study selected the exemplary system's features based on domain knowledge, expert intuition, and previous studies [13], [14] to obtain meaningful and understandable features. To this end, the study evaluated the feature group importance, guided by the Leave-One-Group-Out approach developed by Au et al. [48]. FIG. 4C shows the performance of models trained on different combinations of features to demonstrate feature importance in detecting SE-ads.

As shown in subpanel (a), the property feature group had the lowest area-under-the-curve (AUC) score, whereas the action feature group had the highest score. This result was understandable as the properties of a script did not indicate its maliciousness, and what a script did reflect its objective the most. To better understand what matters most in the action feature group, the study also presented a breakdown in subpanel (b), which depicted that the navigation features were more important than others. The rest of the features contributed almost equally.

Robustness. The study evaluated how well the exemplary system performed against concept-drift [47] by testing the model using the testing dataset. Next, the study tested the robustness of the classifier of the exemplary system by altering feature values to simulate evading the exemplary system.

Machine learning models are known to lose their effectiveness over time due to the underlying changes in the data distribution (i.e., concept drift) used to train the model. The study developed the exemplary system to slow down the degradation process by focusing on the behaviors of the scripts that inject SE-ads. To this end, the study evaluated accuracy of the exemplary system over time by testing it on a dataset crawled in October 2022, almost one year after the initial model of the exemplary system was trained. The study obtained a similar result for the dataset used for FP and FN analysis. The exemplary system achieved an accuracy of 97.37% with a precision of 98.25% and a recall of 97.37%. These results indicated that the study did not need to frequently retrain the exemplary system because the fundamental techniques used by those SE-ads may not change often. However, the study recommended updating the exemplary system and retraining its model every several months for the potentially new JS APIs introduced and employed by ad networks.

The study also evaluated the robustness of the classifier of the exemplary system against evading techniques. Given the limitation of gathering more evading samples, the study simulated evasive SE-ads by altering feature values. The study generated four guidelines based on domain expert intuition of feasible evading techniques: (1) include the malicious script as the first-party script; (2) put the script as an inline script; (3) directly bring the user to SE-websites without redirects; and (4) behave as benign scripts while stealing clicks. Table 10 shows the evasion rates of the four evading techniques.

TABLE 10

| | Evasion |
|---|---|
| Approaches | rate |
| First-party script (Fst.Pty.) | 2.13% |
| Inline script (Inl.) | 5.11% |
| No redirects (NoRdr.) | 3.62% |
| NoRdr. + Fst.Pty. | 2.56% |
| NoRdr. + Inl. + Fst.Pty. | 9.17% |
| Do not request external resources | 1.49% |
| Do not add callbacks | 1.49% |
| Do not attach iframes | 1.92% |
| Do not modify node attributes | 1.70% |

First, the study changed the property feature groups to make the scripts first-party and/or inline. This alternation yielded a maximum of 5.11% evasion rate. Next, the study let the attacks directly bring the users to the SE-websites. This change led to a 3.62% evasion rate. When combining the techniques used for the property features, the evasion rate went up to 9.17%.

The study also tested altering the action features, which was challenging since the study should keep the attacks valid. The study took a conservative approach, keeping the features related to DOM manipulations, including event listener registrations, DOM node modifications, etc. The study only updated the remaining features in this feature group and reported the result in the lower part of Table 10. The study did not report the combination of these behaviors since the evasion rate did not increase significantly. The highest evasion rate was 1.92% by not attaching iframes on the page.

In summary, the study found that the attackers can evade the exemplary system at a high rate only when they include their malicious scripts as first-party by colluding with the website owner or compromising the web servers. However, this was unlikely because the attackers could have better choices of compromising visitors when they could access the web servers.

Comparison between the exemplary system and state-of-the-art systems. The study compared the exemplary system with two state-of-the-art (SoA) tools: Brave Shields, the adblocking module for Brave Browser [18] from industry, and AdGraph [19] from academia. The study first showed that Brave Shields was insufficient using a filter-list-based approach and then showed that AdGraph was not suitable for SE-ads.

Exemplary system versus Traditional blacklist-based ad-blockers. Adblock Plus was a popular blacklist-based ad-blocker that leveraged manually maintained blacklists to deny or whitelists to allow ad or tracker traffic. Brave Browser integrated a variety of filter lists, which were a superset of Adblock Plus, so the study set up its ad-blocking component [49] locally to see how well the exemplary system performed against traditional ad-blockers. Brave Shields took in a script URL and a frame URL and returned a binary decision.

The study fed Brave Shields script URLs along with their corresponding running frame's URLs and analyzed the disagreements between Brave Shields and the ground truth. The study obtained 1,479 positive samples for the training dataset, of which Brave Shields missed 14.74%.

To make a fair comparison, the study tested Brave Shields on two batches of the training datasets. First, the study performed a 70/30 training/testing split of the training dataset, following the data balancing method the study used previously, and trained a model to test the testing split. The second dataset was the testing dataset the study collected in March 2022. To evaluate how well the exemplary system performed against Brave Shields, the study focused on the false negative rate, the rate of evading the detection.

Table 11 shows the false negative rate of detecting SE-ads (in the training dataset) by Brave Shields and the exemplary system. The first batch was 30% split from the training dataset. The second batch was from the testing dataset.

TABLE 11

| | | False |
|---|---|---|
| | False | negative |
| | negative | rate |
| | rate (FNR) | (FNR) by |
| | by Brave | exemplary |
| Dataset | Shields | system |
| First batch | 15.14% | 2.13% |
| Second batch | 12% | 1.49% |

As shown in Table 11, the exemplary system outperformed Brave Shields almost by 7 times.

Exemplary system versus Machine learning-based ad-blockers. The study compared the exemplary system against the two state-of-the-art ad-blocking systems: AdGraph [19], the first ML-based ad-blocking tool that was based on the contents of ads and trackers, and WebGraph [33], the first ML-based ad-blocking tool that was based on the action of ads and trackers. The study shows why AdGraph and WebGraph can not solve the problem the exemplary system was trying to solve.

First, the study replicated AdGraph by crawling Alexa Top 10,000 using the open-sourced AdGraph binary, labeled the data using the latest filter lists as of writing, and built the same classifier as described in the previous study [19]. The study then created the testing dataset by letting AdGraph crawl random P.W. 1,000 websites from website seed list. The accuracy on these sites dropped to 83.25%, which showed that AdGraph for generic ads did not work well for SE-ads.

Next, the study sampled 1,000 websites from the training dataset (referred to as P.W. 1,000 Trn) and 1,000 websites from the testing dataset (referred to as P.W. 1,000 Tst), respectively. For each batch of P.W. 1,000, 500 sites were from websites known to publish SE-ads, and 500 were from benign websites. Then, the study let AdGraph crawl these 2,000 websites and labeled the datasets using the ground truth. Finally, the study trained AdGraph and the exemplary system, on the same training dataset and tested them on the same testing dataset.

Table 12 shows the performance of the exemplary system and AdGraph in detecting generic ads and SE-ads. The “generic ads” was the original AdGraph model and tested on the SE-ads dataset, whereas the “SE-ads” was trained and tested on the SE-ads datasets.

TABLE 12

| | | | | F-1 |
|---|---|---|---|---|
| Model | Accuracy | Precision | Recall | score |
| AdGraph for generic ads | 83.25% | 80.12% | 81.65% | 80.88% |
| AdGraph for SE-ads | 81.51% | 71.34% | 75.33% | 73.28% |
| Exemplary system | 95.07% | 96.11% | 95.49% | 95.79% |

As shown in Table 12, the exemplary system outperformed AdGraph by over 10%. AdGraph trained by P.W. 1,000 Trn performed even worse than the generic model. However, this was not an apple-to-apple comparison. The AdGraph for Generic and AdGraph for SE-ads were two different models as they were trained on different datasets, which were labeled differently. The former targeted generic ads, while the latter targeted SE-ads. Moreover, while replicating AdGraph, the study found URLs with protocol “data:” may be considered as NON-AD in the labeling process of AdGraph. This implied resources using base64 encoded URL may escape AdGraph's detection because AdGraph can extract nothing from such URLs. This gave the adversaries opportunities to import external scripts using the command “data: text/javascript,ZG9Tb211dGhpbmcoKQ==”, which means “doSomething( )” to evade AdGraph.

WebGraph improved the robustness of AdGraph by removing the content features and adding information flows for network, storage, and sharing. Because WebGraph was not open-sourced, to the study cannot evaluate it with the study's datasets. However, WebGraph was not configured to capture how a script manipulated the DOM to lure users to social engineering websites. Hence, its performance on the study's datasets should be equivalent to AdGraph's.

System Overhead. The study evaluated the runtime performance of SEAgent, a component of the exemplary system that may induce overhead, including running time and memory and central processing unit (CPU) usage.

Runtime overhead. To quantify the impact on the user experience, the study measured the page load time to evaluate the runtime overhead for the Tranco top 1,000 websites [50]. To measure this, the study leveraged Chromium's “TRACE_EVENT” instrumentation infrastructure for profiling [51]. The study added a new trace category named “blink.seagent” and put “TRACE_EVENTO” macro at the beginning of each instrumentation hook. Then, the study enabled “blink.user_timing” to measure the page load time, which is defined as the time spent between the navigation request start and the load event end [52]. For each website, the study loaded the page into the browser 10 times and selected the median page-load overhead.

FIG. 4D shows the runtime overhead induced on the page load by the exemplary system for the Tranco 1,000 websites. Subpanel (a) shows the runtime overhead increase for the page load. Subpanel (b) shows the absolute time induced by the exemplary system.

As shown in subpanel (a), the median runtime overhead was 2.13%, which resulted in a 0.02-second increase in the page load time, which was comparable to previous studies [41], [53], [54]. Looking at outliers, the study found the websites that had more DOM modifications were more impacted by the SEAgent. For instance, kickstarter.com took the longest to load, with 14.34% (0.33 seconds) overhead. After checking this website, the study found that JS inserted more than 35,000 DOM nodes, modified their attributes, and then removed half of them before the page was fully loaded. These outliers were rare given that the overhead for the 95% of the Tranco 1,000 list was less than 5.7%.

Resource overhead. To evaluate resource usage overhead of the exemplary system, the study measured the CPU and memory usage for the websites listed in the Tranco top 1,000 [50]. Separately measuring the precise resource consumption of components of the exemplary system may require sophisticated code instrumentation to calculate how much memory was allocated and how many CPU cycles were consumed. Therefore, the study used the “ps” [55] command to continuously record the CPU and memory usage of the browser processes (with 100 ms granularity) while visiting the home page of every website in the Tranco top 1,000 list ten times (i.e., 10,000-page loads in total), using both vanilla Chromium and the exemplary system. Every time a page was visited, the study waited for the page to be fully loaded and then waited another 10 seconds before visiting the next page.

To compare the resource usage of vanilla Chromium and the exemplary system, the study summarized the results as Cumulative Distribution Function (CDF) graphs. FIG. 4E shows the resource usage induced on the page load by the exemplary system. Subpanel (a) shows the distribution of CPU usage. Subpanel (b) shows the distribution of the memory consumed by the exemplary system.

As shown in FIG. 4E, the exemplary system induced negligible CPU overhead and limited memory usage overhead, which was mainly driven by the exemplary system's need to perform data serialization and buffer browser data objects that were then recorded to the exemplary system's trace files.

With 2.13% overhead on page load time, negligible CPU overhead, and small memory overhead compared to the memory available on modern devices, the exemplary system may be deployed in real-world environments to work as a real-time classification system.

Runtime environment. The exemplary system may be deployed as a browser extension with Chrome DevTools Protocol turned on as a prototype, which exposes the existence of the exemplary system. Adversaries may detect the exemplary system and then cloak themselves or refuse to display content until the users turn off the exemplary system. To address this limitation, the exemplary system may be embedded directly into the browser to become invisible to those adversaries.

Data collection and labeling. Unlike previous studies [17], [19], [33], [38], [56], which target generic ads and trackers, the exemplary system targets SE-ads, which are not as ubiquitous as those ads and trackers. The study relied on publicwww.com to collect websites that inject SE-ads. To this end, the diversity of the training dataset was limited to a small number of ad networks, which the study identified by reverse-engineering their ad scripts and searching on the Internet. While the exemplary system performs well based on this dataset, its accuracy may drop when encountering unseen ad network-scripts. However, the exemplary system can periodically retrain its classifier on improved ground truth as the users provide feedback.

First-party ad scripts. The exemplary system failed to detect the navigation initiated by the first-party scripts. The results shown in Table 10 also showed that the attackers might have a higher chance to evade the exemplary system by injecting ad scripts as first-party scripts. However, colluding with the first party to launch SE-ads for SE attacks at scale may be implausible.

### Discussion

Discussion #1. Social Engineering (SE) has become a more sophisticated and common attack method [1]. Recent surveys report that 84% of hackers leverage Web-based Social Engineering Attacks (WSEAs) in the cyber kill chain with a high success rate [2-4]. Moreover, 64% of companies have experienced web-based attacks, and 62% have seen phishing and WSEAs [5]. Attackers also target regular Internet users. The Federal Trade Commission received 2.8 million fraud reports in 2021 in the United States, which led to a $5.8 billion financial loss [6]. The top 3 fraud categories impostor scams (e.g., tech support scams), online shopping scams, and reward and prize scams (e.g., survey scams) are commonly seen on the Internet [7-10]. These scams account for $2.3 billion of losses, almost doubling from 2020.

Researchers have studied countermeasures to mitigate the impact of WSEAs. For example, Miramirkhani et al. analyzed tech support scams [7]; Kharraz et al. built Surveillance [8], which was specifically designed to detect survey scams, and Invernizzi et al. developed EVILSEED [11], a crawler that searched the Internet to identify risky websites that install unwanted software. However, these previous studies only focused on specific SE attack vectors. Because of the diversity of WSEAs that users can encounter [1], there is a need for new and more effective in-browser defense systems that can accurately detect generic WSEAs.

The instant study developed the exemplary system that aims to detect and block generic WSEAs in real time while the user is browsing the web. Directly detecting malicious web pages related to WSEAs may be difficult due to the large variety of SE tactics attackers can employ and the freedom they have in building malicious content. Therefore, the study investigated how to indirectly detect and block WSEAs at their inception before the user interacts with the related scam content.

Previous studies have shown that users often reach Social Engineering Websites (SE-websites) by interacting with malicious ads [7-9], [12-16]. More specifically, attackers are inclined to leverage low-tier ad networks to inject ads into many different publisher websites at scale and use these ads to lure users to their SE websites so that various attacks such as lottery scams, reward scams, tech support scams, etc., can be launched. Importantly, these low-tier ad networks often do not inject traditional ads onto the page. Instead, they inject DOM elements into ad-publishing web pages and leverage different social engineering tricks to lure users into clicking these elements to trigger ad network-driven navigation to a WSEA page. For instance, the ad network may inject a transparent overlay covering the entire publisher page and listen to users click on any portion of the page. The study referred to these nontraditional ads that leverage various SE tricks to lure users' clicks as Social Engineering Ads (SE-ads).

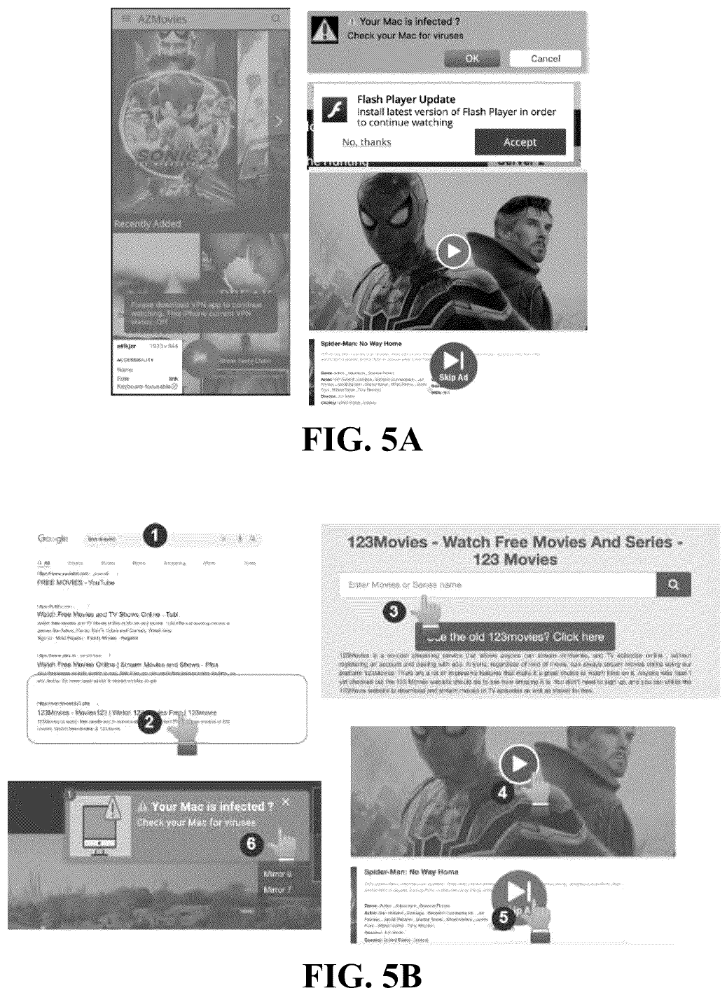

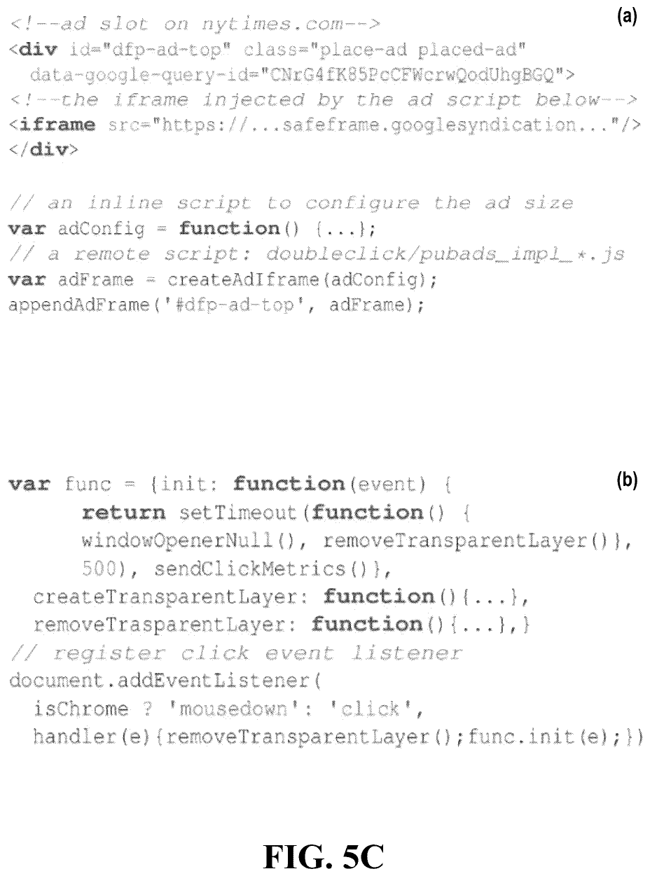

SE-ads are non-traditional ads. They are often invisible, malicious ads that, when interacted with, navigate the browser to a landing page containing SE attacks. FIG. 5A shows example social engineering advertisements (SE-ads).

A previous study [13] reported that attackers often leverage two types of techniques for SE-ads: (1) registering click event listeners and injecting invisible links (shown in subpanel a) to deploy invisible, malicious ads to steal users' clicks, and (2) making SE-ads appear as misleading in-page components, such as an in-page push notification or fake “Skip Ads” or “Play” buttons (shown in subpanel b) to induce users to interact with them. Rather than attempting to detect WSEAs directly by analyzing their contents and/or URLs related to the WSEAs, the study focused on detecting their leading causes, namely SE-ads.

Although most SE-ads come from ad networks, existing ad-blocking tools are not effective in detecting SE-ads for two reasons. First, the ads are not generally visible, so ad-blocking tools such as PERCIVAL [17], which block ads through the image rendering pipeline, cannot detect them. Second, the ad networks that distribute these SE-ads are motivated to evade ad blockers [9].

The exemplary system employs an in-memory graph representation of a web page and its activities (e.g., registering event listeners to intercept clicks, manipulating the Document Object Model (DOM) to inject deceptive elements), which is known as the Web Action History Graph (WAHG). During a user's browsing session, the exemplary system uses the WAHG to protect users from potential SE attacks that are launched through SE ads in real-time. Specifically, during a user's browsing session, the exemplary system vets each navigation event to determine if an SE-ad initiates it.

When the exemplary system detects the navigation is related to a SE-ad, the exemplary system redirects the user to an interstitial page to warn the user.

To evaluate the exemplary system, the study crawled over 100,000 websites from October 2021 to January 2022 and collected 258,008 unique navigation events initiated by JavaScript (JS), including 1,479 events resulting in SE attacks. The study found that the exemplary system can detect SE-ads with an accuracy of 92.63%, a precision of 90.63%, and a recall of 96.28%, outperforming state-of-the-art systems [19] by more than 10%.

In line with previous studies [9], [10], [53] that need to crawl the Internet, the study also simulated users' clicks on ad publishers using crawlers, which may lead to advertisers' landing pages. The crawlers did not target any specific ads or ad campaigns. They randomly chose ten clickable elements and ten links. These clicks resulted in 5,726 opened windows that loaded benign content. Assuming that all of these windows eventually reached the landing pages of advertisers, the study found that a crawler made two clicks on the ads for each advertiser on average. Considering the average CPC (cost per click) being USD $0.75 [25], the cost to each advertiser would be USD $1.5 on average. This result shows that the crawling experiment in the study ensured minimal financial losses for legitimate advertisers while generating results that helped prevent people from falling into WSEAs.

Discussion #2. An example scenario in which a user is directed to a SE-websites: Alice types “free movies” in Google Search but ends up landing on SE-websites. FIG. 5B shows an example of how an ad network manipulates users to interact with SE-ads by including JavaScript (JS) code into a content-sharing website, also known as an ad publisher.

As shown in FIG. 5B, the attack begins on the popular Google search engine where the victim, Alice, completes a Google search for the phrase “free movies” at step (1). Despite Google Search being a respected search engine, it still struggles to filter out websites that include malicious content from the top results of the search. For instance, Google Search returns an illegal movie-sharing website (ww.movies123.sbs) in the top 4 results for the query “free movies” at step (2). As a result, Alice is supplied with a mixture of benign and malicious search results. As this is one of the top results, many users may click on the link to www.movies123.sbs, which is not considered malicious by VirusTotal [20] or Google Safe Browsing [21].

At first glance, this website appears innocuous while also providing a diverse selection of popular, well-known movies. However, under the hood, www.movies123.sbs includes scripts obtained from low-tier ad networks with one goal: to trick visitors into clicking on the SE-ads these scripts inserted so they can make money from their malicious activity. Looking at FIG. 5B, several mouse event listeners, registered on “#document”, intercept Alice's click on the search box in step (3). In fact, any click on the page triggers the listeners, which dynamically determines what page to open for Alice. Due to these click interceptions, Alice is obligated to interact with SE-ads when searching for a movie to watch. Before Alice can type the movie name, the SE-ad opens up a new tab, asking Alice to install “Rainbow Blocker”, a known AdWare [22]. When Alice arrives at the Spider-Man movie, she clicks on the play button in step (4) and “Skip Ads” in step (5). Unfortunately, the SE-ads are attempting to trick Alice into downloading browser extensions, which claim to be necessary to watch the movie. However, after further manual analysis of their code, the study found that these extensions were trackers and Ad-Ware, which track users and harm their digital privacy. After seven clicks, Alice could watch the movie after closing all the opened tabs. While Alice is watching, an in-page notification pops up to warn Alice that her Mac is infected. Alice becomes nervous and clicks on the banner to download software to clean her Mac in step 6. This software was confirmed to be an AdWare by VirusTotal [20].

Ad publishers are inclined to cooperate with low-tier ad networks, which pay more than high-profile advertising platforms [23]. For example, AdSterra pays up to USD $25 for a click [24], which is 10× more than what Google ads pay. Therefore, these low-tier ad networks are strongly motivated to elicit clicks to collect more money [25]. FIG. 5C shows the script snippets from Google Ads and AdSterra. Subpanel (a) shows the script snippet from Google Ads that follows ad standards. Subpanel (b) shows the script snippet from AdSterra that injects SE-ads into web browsers.

The low-tier ad networks may use SE tricks to harvest as many clicks as possible. Specifically, as shown in subpanel (b), the low-tier ad networks inject in-line scripts to insert a transparent DOM layer and register a mouse event listener. The visitor is then forced to trigger the event listener, which opens a new window and loads ads. This approach is highly different from what the high-profile ad networks do and does not follow the general standards [26-29]. In contrast, as shown in subpanel (a), the ad publisher prepares a container for the ad script to inject an iframe that can isolate the ad's contents such that it cannot directly access the first party's contents. The ads shown in subpanel (b) may collect fewer clicks than low-tier networks.

Therefore, as ad publishers, these content-sharing websites prefer low-tier ad networks even though these ad networks may use SE tricks to get more clicks. Thus, the low-tier ad networks can transfer a fraction of their high revenue from advertisers to those ad publishers. The advertisers are satisfied by having more ads exposed to users, which results in a higher conversion rate. This business model is intriguing to attackers and provides them with opportunities to spread malicious content (e.g., unwanted software, WSEAs).

### CONCLUSION

The construction and arrangement of the systems and methods, as shown in the various implementations, are illustrative only. Although only a few implementations have been described in detail in this disclosure, many modifications are possible (e.g., variations in sizes, dimensions, structures, shapes, proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementation of the present disclosure may be implemented using existing computer processors, or by a special purpose computer processor for an appropriate system, incorporated for this or another purpose, or by a hardwired system. Implementations within the scope of the present disclosure include program products, including machine-readable media for carrying or having machine-executable instructions or data structures stored thereon. Such machine-readable media can be any available media that can be accessed by a general-purpose or special-purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data that cause a general-purpose computer, special-purpose computer, or special-purpose processing machine to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with programming techniques with rule-based logic and other logic to accomplish the various connection steps, processing steps, comparison steps, and decision steps.

Each and every feature described herein, and each and every combination of two or more of such features, is included within the scope of the present invention, provided that the features included in such a combination are not mutually inconsistent.

Although example embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

It must also be noted that, as used in the specification and the appended claims, the singular forms “a,” “an” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including matters of logic with respect to the arrangement of steps or operational flow, plain meaning derived from grammatical organization or punctuation, and the number or type of embodiments described in the specification.

While the methods and systems have been described in connection with certain embodiments and specific examples, it is not intended that the scope be limited to the particular embodiments set forth, as the embodiments herein are intended in all respects to be illustrative rather than restrictive.

The following patents, applications, and publications, as listed below and throughout this document, are hereby incorporated by reference in their entirety herein.
[1] Fatima Salahdine and Naima Kaabouch. “Social engineering attacks: A survey”. In: Future
Internet 11.4 (2019), p. 89.
[2] Fully 84 Percent of Hackers Leverage Social Engineering in Cyber Attacks. https://www. esecurityplanet.com/threats/fully-hackers-leverage-social-engineering-in-cyber-attacks/.2017.
[3] The Social Engineering Infographic-Security Through Education. https://www.social-engineer.org/socialengineering/social-engineering-infographic/.
[4] Gianpiero Costantino et al. “CANDY: A social engineering attack to leak information from infotainment system”. In: 2018 IEEE 87th Vehicular Technology Conference (VTC Spring). IEEE. 2018, pp. 1-5.
[5]15 Alarming Cyber Security Facts and Stats Cybint. https://www.cybintsolutions.com/cyber-security-factsstats/.2020.
[6] New Data Shows FTC Received 2.8 Million Fraud Reports from Consumers in 20211 Federal Trade Commission. https://www.ftc.gov/news-events/news/press-releases/2022/02/new-data-shows-ftc-received-28-million-fraud-reports-consumers-2021-0.2022.
[7] Najmeh Miramirkhani, Oleksii Starov, and Nick Nikiforakis. “Dial One for Scam: A Large-Scale Analysis of Technical Support Scams”. In: 2017. DOI: 10.14722/ndss.2017.23163.
[8] Amin Kharraz, William Robertson, and Engin Kirda. “Surveylance: Automatically Detecting Online Survey Scams”. In: Proceedings-IEEE Symposium on Security and Privacy. Vol. 2018-May. Institute of Electrical and Electronics Engineers Inc., July 2018, pp. 70-86. ISBN: 9781538643525. DOI: 10.1109/SP.2018.00044.
[9] Phani Vadrevu and Roberto Perdisci. “What you see is not what you get: Discovering and tracking social engineering attack campaigns”. In: Proceedings of the ACM SIGCOMM Internet Measurement Conference, IMC (2019), pp. 308-321. DOI: 10.1145/3355369.3355600.
[10] Karthika Subramani et al. “When Push Comes to Ads: Measuring the Rise of (Malicious) Push Advertising”. In: {IMC}'20: {ACM}Internet Measurement Conference, Virtual Event, USA, Oct. 27-29, 2020. 2020, pp. 724-737. ISBN: 9781450381383. URL: https://doi.org/10.1145/3419394.3423631.
[11] Luca Invernizzi et al. “EvilSeed: A guided approach to finding malicious web pages”. In: Proceedings—IEEE Symposium on Security and Privacy. Institute of Electrical and Electronics Engineers Inc., 2012, pp. 428-442. ISBN: 9780769546810. DOI: 10.1109/SP.2012.33.
[12]M. Zubair Rafique et al. “It's Free for a Reason: Exploring the Ecosystem of Free Live Streaming Services”. In: Internet Society, May 2017. DOI: 10.14722/ndss.2016.23030.
[13] Mingxue Zhang et al. “All your clicks belong to me: Investigating click interception on the web”. In: Proceedings of the 28th USENIX Security Symposium. 2019.
[14] Ting Yu et al. “Knowing Your Enemy: Understanding and Detecting Malicious Web Advertising”. In: p. 1070. ISBN:9781450316514.
[15] USENIX Association., ACM SIGMOBILE., and ACM Digital Library. “Towards Measuring and Mitigating Social Engineering Software Download Attacks”. In: USENIX Association, 2005, p. 48. ISBN: 9781931971324.
[16] Apostolis Zarras et al. “The dark alleys of madison avenue: Understanding malicious advertisements”. In: Proceedings of the ACM SIGCOMM Internet Measurement Conference, IMC. Association for Computing Machinery, November 2014, pp. 373-379. ISBN: 9781450332132. DOI: 10. 1145/2663716. 2663719.
[17] Zain Ul Abi Din et al. “PERCIVAL: Making in-browser perceptual ad blocking practical with deep learning”. In: Proceedings of the 2020 USENIX Annual Technical Conference. 2020. ISBN: 9781939133144.
[18] Blocking goals and policy-Brave Browser Wiki. [Online; accessed 20 Jan. 2022]. 2021. URL: https://github.com/brave/brave-browser/wiki/Blocking-goalsand-policy.
[19] Umar Iqbal et al. “AdGraph: A graph-based approach to ad and tracker blocking”. In: Proceedings-IEEE Symposium on Security and Privacy 2020-May (2020), pp. 763-776. ISSN:10816011. DOI: 10.1109/SP40000.2020.00005.
[20] VirusTotal. [Online; accessed 20 Jan. 2022]. 2022. URL: https://virustotal.com.
[21] Google Safe Browsing|Google Developers. https://developers.google.com/safe-browsing/.2022.
[22] Rainbow Blocker Adware-Easy removal steps (updated). https://www.pcrisk.com/removal-guides/23298-rainbow-blocker-adware. 2022.
[23] How Much Money Do Websites Make From Advertising?https://adsterra.com/blog/how-much-money-websites-make-from-ads/.2020.
[24] Best CPM Rates for Publishers and Webmasters. https://adsterra.com/blog/geos-with-high-cpm-ratesfor-publishers/.
[25] Google Display Ads CPM, CPC, & CTR Benchmarks in Q1 2018. https://blog.adstage.io/google-displayads-cpm-cpc-ctr-benchmarks-in-q1-2018. 2018.
[26] Better Ads Standards-Google Ad Manager. https://admanager.google.com/home/resources/feature-brief-better-ads-standards/.2018.
[27] Advertising and Marketing on the Internet: Rules of the Road Federal Trade Commission. https://www.ftc.gov/business-guidance/resources/advertising-marketing-internet-rules-road. 2022.
[28] What are IAB Standard Ads?Why are They Important?https://www.adpushup.com/blog/what-are-iabstandard-ads-why-are-they-important/.2021.
[29] IAB New Ad Portfolio: Advertising Creative Guidelines. https://www. iab.com/guidelines/iab-new-ad-portfolio/.2022.
[30] EasyList. [Online; accessed 20 Jan. 2022]. 2022. URL: https://easylist.to/.
[31] blocklistproject/Lists: Primary Block Lists. [Online; accessed 5-Jun. 2022]. 2022. URL: https://github.com/blocklistproject/Lists.
[32] uBlock Origin-Free, open-source ad content blocker. https://ublockorigin.com/.2022.
[33] Sandra Siby et al. WEBGRAPH: Capturing Advertising and Tracking Information Flows for Robust Blocking.Tech.rep.
[34] Florian Tramer et al. “AdVersarial: Perceptual Ad Blocking meets Adversarial Machine Learning”. In: Proceedings of the 2019 ACM SIGSAC Conference on Computer and Communications Security. 2019, pp. 2005-2021. ISBN:9781450367479.
[35] Chrome DevTools Protocol. [Online; accessed 20 Jan. 2022]. 2022. URL: https://chromedevtools.github.io/devtools-protocol/.
[36] Iskander Sanchez-Rola et al. “Dirty Clicks: A Study of the Usability and Security Implications of Click-Related Behaviors on the Web”. In: Proceedings of The Web Conference 2020.WWW'20. Taipei, Taiwan: Association for Computing Machinery, 2020, 395-406. ISBN: 9781450370233.
[37] Takashi Koide, Daiki Chiba, and Mitsuaki Akiyama. “To Get Lost is to Learn the Way: Automatically Collecting Multi-Step Social Engineering Attacks on the Web”. In: Proceedings of the 15th ACM Asia Conference on Computer and Communications Security. ASIA CCS '20. Taipei, Taiwan: Association for Computing Machinery, 2020, 394-408. ISBN: 9781450367509.
[38] Umar Iqbal et al. KHALEESI: Breaker of Advertising and Tracking Request Chains.Tech. rep.
[39] Leo Breiman. “Random forests”. In: Machine learning 45.1 (2001), pp. 5-32.
[40] Search Engine for Source Code—PublicWWW.com. https://publicwww.com/.2022.
[41] Quan Chen et al. “Detecting Filter List Evasion With Event-Loop-Turn Granularity JavaScript Signatures”. In: IEEE Symposium on Security and Privacy (S&P) (2021).
[42] Puppeteer. [Online; accessed 20 Jan. 2022]. 2022. URL: https://pptr.dev/.
[43][43] Kind of Like That—The Hacker Factor Blog. https://www.hackerfactor.com/blog/index.php?/archives/529-Kind-of-Like-That.html.
[44] Miroslav Kubat, Stan Matwin, et al. “Addressing the curse of imbalanced training sets: one-sided selection”. In: Icml. Vol. 97. 1. Citeseer. 1997, p. 179.
[45] Hui Han, Wen-Yuan Wang, and Bing-Huan Mao. LNCS 3644-Borderline-SMOTE: A New Over-Sampling Method in Imbalanced Data Sets Learning. Tech. rep. 2005, pp. 878-887.
[46] Get more likes, shares and follows with smart website tools—AddThis. https://www.addthis.com/.
[47] Alexey Tsymbal. “The problem of concept drift: definitions and related work”. In: Computer Science Department, Trinity College Dublin 106.2 (2004), p. 58.
[48] Quay Au et al. “Grouped feature importance and combined features effect plot”. In: arXiv preprint arXiv:2104.11688 (2021).
[49] brave/adblock-rust. [Online; accessed 20 Jan. 2022]. 2021. URL: https://github.com/brave/adblock-rust.
[50] Victor Le Pochat et al. “Tranco: A research-oriented top sites ranking hardened against manipulation”. In: arXiv preprint arXiv:1806.01156 (2018).
[51] The Trace Event Profiling Tool (about:tracing). https://www. chromium.org/developers/how-tos/trace-event-profiling-tool/.2022.
[52] Page load time-MDN Web Docs Glossary: Definitions of Web-related terms MDN. https://developer.mozilla.org/en-US/docs/Glossary/Page_load_time. 2022.
[53] Joey Allen et al. “Mnemosyne: An Effective and Efficient Postmortem Watering Hole Attack Investigation System”. In: Proceedings of the ACM Conference on Computer and Communications Security. Association for Computing Machinery, October 2020, pp. 787-802. ISBN: 9781450370899. DOI:10.1145/3372297.3423355.
[54] Bo Li et al. “JSgraph: Enabling Reconstruction of Web Attacks via Efficient Tracking of Live In-Browser JavaScript Executions”. In: Network and Distributed Systems Security (NDSS) Symposium February (2018). DOI: 10.14722/ndss.2018.23319.
[55] ps(1)—Linux manual page. 2022. URL: https://man7.org/linux/man-pages/man1/ps.1.html.
[56] Umar Iqbal, Steven Englehardt, and Zubair Shafiq. “Fingerprinting the fingerprinters: Learning to detect browser fingerprinting behaviors”. In: 2021 IEEE Symposium on Security and Privacy (SP). IEEE. 2021, pp. 1143-1161.
[56] Jochem van de Laarschot and Rolf van Wegberg. “Risky business?Investigating the security practices of vendors on an online anonymous market using ground-truth data”. In: Proceedings of the 30th USENIX Security Symposium. 2021.
[57] Clickjacking|OWASP Foundation. https://owasp.org/www-community/attacks/Clickjacking.
[58] X-Frame-Options-HTTP|MDN. https://developer. mozilla.org/en-US/docs/Web/HTTP/Headers/X-Frame-Options. 2022.
[59] Stefano Calzavara et al. “A Tale of Two Headers: A Formal Analysis of Inconsistent Click-Jacking Protection on the Web”. In: 29th USENIX Security Symposium (USENIX Security 20). USENIX Association, August 2020, pp. 683-697. ISBN: 978-1-939133-17-5.
[60] Lin Shung Huang et al. “Clickjacking: Attacks and defenses”. In: Proceedings of the 21st USENIX Security Symposium. 2012.
[61] Marco Balduzzi et al. “A solution for the automated detection of clickjacking attacks”. In: Proceedings of the 5th International Symposium on Information, Computer and Communications Security, ASIACCS 2010. 2010. DOI: 10.1145/1755688.1755706.
[62] Devdatta Akhawe et al. “Clickjacking revisited a perceptual view of UI security”. In: 8th USENIX Workshop on Offensive Technologies, WOOT 2014. 2014.

What is claimed:

1. A system comprising;
a processor; and
a memory having instruction stored thereon, wherein execution of the instructions causes the processor to:
execute a user interface module, a browser engine, a rendering engine, a networking module, a JavaScript engine, and a data storage module for a web browser;
in response to initiating a browsing session for a new website by a user, receive a set of property values, a set of action values, and a set of consequence values associated with the browsing session for the new website from instrumented hooks embedded in the browser engine, the rendering engine, the networking module, the JavaScript engine, and the data storage module;
determine, via a trained AI model, a score for the browsing session being associated with a website having a malicious component; and
output the score, wherein the score is employed to prevent the user from selecting an actionable component in a rendered website.

2. The system of claim 1, wherein execution of the instructions causes the processor to:
output a notification indicating the presence of an actionable component for a rendered website.

3. The system of claim 1, wherein the set of property values is associated with a compilation and execution of a script of the rendered website and includes at least one of:
an execution context of a running script as a top frame or a subframe,
an execution context of the running script having a same origin frame or cross-origin frame,
a type of script as an inline script in HTML,
a type of script as a remote script file,
a type of script as a dynamically generated script,
an owner of the script being served by a first-party server,
an owner of the script being served by a third-party server,
a requestor being an HTML parser, and
a requestor being from another script that is not an HTML parser.

4. The system of claim 1, wherein the set of action values is associated with an observed behavior exhibited by a script of the rendered website and includes at least one of:
a register event listener action having an event type associated with a keyboard, mouse, and/or hover,
a register event listener action having an event target as a type of DOM element,
an add timer callback action as a setTimeout,
an add timer callback action as a setInterval,
an add timer callback action as an interval,
an insert DOM node action using an <a > inserted node type,
an insert DOM node action using a <script> inserted node,
an insert DOM node action using a <div> inserted node,
a modify DOM node attribute,
a modify DOM node attribute action using a “style” attribute,
a modify DOM node attribute,
a modify DOM node attribute action using a “href” attribute,
a modify DOM node attribute,
a modify DOM node attribute action using a “src” attribute,
an open-new-window action using a URL for a new window,
a render window using a tab window from an open-new-window action,
a render window using a full window from an open-new-window action,
an initiate navigation action with a URL of a navigation target,
an initiate navigation action from a top frame,
an initiate navigation action with a URL from an iframe,
an initiate navigation action within a same-origin,
an initiate navigation action by a client code,
an initiate navigation action by the browser by user action,
a send network request action via a URL of the request,
a send network action via a script,
a send network action via an image,
a send network action via a document, and
a send network action via a JavaScript object notation (JSON).

5. The system of claim 1, wherein the set of consequence values is associated with an observed behavior of the browser after navigation from the rendered website and includes at least one of:
a number of redirected hops until landing at a destination page,
a number of unique domains of the redirected hops,
a redirect type being code-driven, and
a redirect type being response-header-driven.

6. The system of claim 1, wherein the trained AI model was trained using a set of features populated using a web crawler, wherein the web crawler was configured to simulate user interactions with the respective website to trigger one or more JavaScript events.

7. The system of claim 1, wherein the trained AI model was trained using a set of features populated using a web crawler, wherein the web crawler was configured to create an in-memory graph where, after visiting each respective website, the graph is dumped into a disk and features are extracted based on a causality relationship of nodes for each website.

8. The system of claim 1, wherein the initiating the browsing session includes:
parsing, via an HTML parser, an HTML document to start rendering a page, wherein the parsing, constructing an in-memory graph, and updating the in-memory graph when a respective instrumented hook embedded in the browser engine is triggered.

9. The system of claim 1, wherein the initiating the browsing session includes:
concluding a feature vector before the browser commits to a new landing page to infer whether the navigation is related to a social engineering attack.

10. A method comprising:
executing a user interface module, a browser engine, a rendering engine, a networking module, a JavaScript engine, and a data storage module for a web browser;
in response to initiating a browsing session for a new website by a user, receiving a set of property values, a set of action values, and a set of consequence values associated with the browsing session for the new website from instrumented hooks embedded in the browser engine, the rendering engine, the networking module, the JavaScript engine, and the data storage module;
determining, via a trained AI model, a score for the browsing session being associated with a website having a malicious component; and
outputting the score, wherein the score is employed to prevent the user from selecting an actionable component in a rendered website.

11. The method of claim 10 further comprising:
outputting a notification indicating the presence of an actionable component for a rendered website.

12. The method of claim 10, wherein the set of property values is associated with a compilation and execution of a script of the rendered website and includes at least one of:
an execution context of a running script as a top frame or a subframe,
an execution context of the running script having a same origin frame or cross-origin frame,
a type of script as an inline script in HTML,
a type of script as a remote script file,
a type of script as a dynamically generated script,
an owner of the script being served by a first-party server,
an owner of the script being served by a third-party server,
a requestor being an HTML parser, and
a requestor being from another script that is not an HTML parser.

13. The method of claim 10, wherein the set of action values is associated with an observed behavior exhibited by a script of the rendered website and includes at least one of:
a register event listener action having an event type associated with a keyboard, mouse, and/or hover,
a register event listener action having an event target as a type of DOM element,
an add timer callback action as a setTimeout,
an add timer callback action as a setInterval,
an add timer callback action as an interval,
an insert DOM node action using an <a > inserted node type,
an insert DOM node action using a <script> inserted node,
an insert DOM node action using a <div> inserted node,
a modify DOM node attribute,
a modify DOM node attribute action using a “style” attribute,
a modify DOM node attribute,
a modify DOM node attribute action using a “href” attribute,
a modify DOM node attribute,
a modify DOM node attribute action using a “src” attribute,
an open-new-window action using a URL for a new window,
a render window using a tab window from an open-new-window action,
a render window using a full window from an open-new-window action,
an initiate navigation action with a URL of a navigation target,
an initiate navigation action from a top frame,
an initiate navigation action with a URL from an iframe,
an initiate navigation action within a same-origin,
an initiate navigation action by a client code,
an initiate navigation action by the browser by user action,
a send network request action via a URL of the request,
a send network action via a script,
a send network action via an image,
a send network action via a document, and
a send network action via a JavaScript object notation (Json).

14. The method of claim 10, wherein the set of consequence values is associated with an observed behavior of the browser after navigation from the rendered website and includes at least one of:
a number of redirected hops until landing at a destination page,
a number of unique domains of the redirected hops,
a redirect type being code-driven, and
a redirect type being response-header-driven.

15. The method of claim 10, wherein the trained AI model was trained using a set of features populated using a web crawler, wherein the web crawler was configured to simulate user interactions with the respective website to trigger one or more JavaScript events.

16. The method of claim 10, wherein the trained AI model was trained using a set of features populated using a web crawler, wherein the web crawler was configured to create an in-memory graph where, after visiting each respective website, the graph is dumped into a disk and features are extracted based on a causality relationship of nodes for each website.

17. The method of claim 10, wherein the initiating the browsing session includes:
parsing, via an HTML parser, an HTML document to start rendering a page, wherein the parsing, constructing an in-memory graph, and updating the in-memory graph when a respective instrumented hook embedded in the browser engine is triggered.

18. The method of claim 10, wherein the initiating the browsing session includes:
concluding a feature vector before the browser commits to a new landing page to infer whether the navigation is related to a social engineering attack.

19. A non-transitory computer-readable medium having instructions stored thereon, wherein execution of the instructions by a processor causes the processor to:
execute a user interface module, a browser engine, a rendering engine, a networking module, a JavaScript engine, and a data storage module for a web browser;
in response to initiating a browsing session for a new website by a user, receive a set of property values, a set of action values, and a set of consequence values associated with the browsing session for the new website from instrumented hooks embedded in the browser engine, the rendering engine, the networking module, the JavaScript engine, and the data storage module;
determine, via a trained AI model, a score for the browsing session being associated with a website having a malicious component; and
output the score, wherein the score is employed to prevent the user from selecting an actionable component in a rendered website.

20. The non-transitory computer-readable medium of claim 19, wherein execution of the instructions causes the processor to:
output a notification indicating presence of an actionable component for a rendered website.
